(19) United States
(12) Patent Application Publication
(10) Pub. No.: US 2026/0037247 A1
(43) Pub. Date: Feb. 5, 2026

(54) Method and Apparatus for Updating Software of Electronic Control Units for Vehicles

(71) Applicant: FESCARO Co., Ltd., Suwon-si (KR)

(72) Inventors: Seok Min HONG, Hanam-si (KR); Hyun Jung LEE, Namyangju-si (KR)

(21) Appl. No.: 18/957,914

(22) Filed: Nov. 25, 2024

(30) Foreign Application Priority Data
Nov. 23, 2023 (KR) 10-2023-0164576
Dec. 28, 2023 (KR) 10-2023-0194269

(51) Int. Cl. G06F 8/65; G06Q 30/018

(52) U.S. Cl. CPC G06F 8/65; G06Q 30/018

(57) ABSTRACT

Provided are a method and device for evaluating whether an individual vehicle is in compliance with automotive regulations. The method of evaluating whether an individual vehicle is in compliance with automotive regulations includes, based on confirming a connection to a vehicle, collecting, from a management controller, a primary determination result on whether the vehicle is in compliance with automotive regulations, comparing a version of a vehicle type database collected from the management controller, with a version of a master database, to determine whether the versions are identical to each other, and generating a secondary determination result on whether the vehicle is in compliance with the automotive regulations, based on the primary determination result and a determination result on whether the version of the vehicle type database and the version of the master database are identical to each other.

### CROSS-REFERENCE TO RELATED APPLICATIONS

This application is based on and claims priority under 35 U.S.C. § 119 to Korean Patent Applications No. 10-2023-0164576, filed on Nov. 23, 2023, and No. 10-2023-0194269, filed on Dec. 28, 2023, in the Korean Intellectual Property Office, the disclosures of which are incorporated by reference herein in their entirety.

### BACKGROUND

### 1. Field

The present disclosure relates to a method and device for evaluating whether an individual vehicle is in compliance with automotive regulations. The present disclosure also relates to a method and system for managing secure software updates for compliance with automotive regulations.

### 2. Description of the Related Art

In the automotive industry, it is crucial to manage vehicles such that they are continuously in compliance with safety, environmental, and various other regulations even after they are produced. Before releasing vehicles, the manufacturer must satisfy roughly 40 to 60 different automotive regulations for each vehicle type. Each detailed regulatory item may be related to a plurality of electronic control units (ECUs). In order for a vehicle to be in compliance with regulations, the manufacturer may perform software (SW) updates on ECUs for various purposes, such as improving performance, resolving quality issues, or adding new features. Even if a vehicle is, at the time of its release, in compliance with all automotive regulations, such as safety and environmental regulations, subsequent SW updates may affect the existing regulatory compliance status and pose a risk of non-compliance. Therefore, vehicle manufacturers need to continuously perform SW updates on the controllers to ensure compliance with automotive regulations.

Meanwhile, the global automotive industry is facing a new regulatory environment where vehicles must continue to comply with safety, environmental, and other regulatory items even after SW updates are made after the vehicles are released. This may mean that the SW must continue to meet regulatory requirements even after the vehicles are on the market.

Conventional software update procedures are mainly performed manually at repair shops, and this process is carried out by using diagnostic equipment. A mechanic checks whether the SW version of the vehicle meets regulatory requirements and then performs an update. This conventional method has several problems. First, there is a risk that an incorrect SW version may be installed due to human error by the mechanic. Second, the SW update process may be hacked and altered due to cybersecurity threats. Third, this method has the limitation that the validity can only be proven when the vehicle is at the repair shop, and the validation is infeasible while the vehicle is driving.

The above-mentioned background art is technical information possessed by the inventor for the derivation of the present disclosure or acquired during the derivation of the present disclosure, and cannot necessarily be said to be a known technique disclosed to the general public prior to the filing of the present disclosure.

### SUMMARY

An objective of the present disclosure is to evaluate whether current hardware (HW) versions and software (SW) versions of vehicle controllers are in compliance with automotive regulations.

Another objective of the present disclosure is to securely perform SW updates for performance enhancement, quality improvement, and addition of new features, while complying with new regulations throughout the entire life cycle of a vehicle.

Another objective of the present disclosure is to validate an SW version of each execution controller and perform an appropriate update as needed, even when the vehicle is not at a repair shop but is in operation or stopped.

Technical objectives of the present disclosure are not limited to the foregoing, and other unmentioned objectives or advantages of the present disclosure would be understood from the following description and be more clearly understood from the embodiments of the present disclosure. In addition, it would be appreciated that the objectives and advantages of the present disclosure may be implemented by means provided in the claims and a combination thereof.

According to an embodiment, a method, performed by a processor of diagnostic equipment, of evaluating whether an individual vehicle is in compliance with automotive regulations may include, based on confirming a connection to a vehicle, collecting, from a management controller, a primary determination result on whether the vehicle is in compliance with automotive regulations by comparing a vehicle type database that stores detailed information about the vehicle, with a vehicle status database that stores current configuration information about the vehicle collected from a plurality of execution controllers, comparing a version of the vehicle type database collected from the management controller, with a version of a master database that stores comprehensive information about all vehicle types, to determine whether the versions are identical to each other, and generating a secondary determination result on whether the vehicle is in compliance with the automotive regulations, based on the primary determination result and a determination result on whether the version of the vehicle type database and the version of the master database are identical to each other.

According to an embodiment, a device for evaluating whether an individual vehicle is in compliance with automotive regulations includes a processor, and a memory operatively connected to the processor and storing at least one piece of code to be executed by the processor, wherein the memory stores code that, when executed by the processor, causes the processor to, based on confirming a connection to a vehicle, collect, from a management controller, a primary determination result on whether the vehicle is in compliance with automotive regulations by comparing a vehicle type database that stores detailed information about the vehicle, with a vehicle status database that stores current configuration information about the vehicle collected from a plurality of execution controllers, compare a version of the vehicle type database collected from the management controller, with a version of a master database that stores comprehensive information about all vehicle types, to determine whether the versions are identical to each other, and generate a secondary determination result on whether the vehicle is in compliance with the automotive regulations, based on the primary determination result and a determination result on whether the version of the vehicle type database and the version of the master database are identical to each other.

According to another embodiment, a method, performed by a management controller provided in a vehicle, of evaluating whether an individual vehicle is in compliance with automotive regulations includes collecting, from a plurality of execution controllers, a vehicle state database that stores current configuration information about the vehicle, determining whether the vehicle is in compliance with automotive regulations, by comparing a vehicle type database that stores detailed information about the vehicle, with the vehicle status database, and recording, in the vehicle status database, a result of determining whether the vehicle is in compliance with the automotive regulations.

In addition, other methods and systems for implementing the present disclosure, and a computer-readable recording medium having recorded thereon a computer program for executing the methods may be further provided.

Other aspects, features, advantages other than those described above will become apparent from the following drawings, claims, and detailed description of the present disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram illustrating an example of an environment for managing secure software updates for compliance with automotive regulations, according to an embodiment;

FIG. 2 is a block diagram schematically illustrating a configuration of a vehicle, diagnostic equipment, and a management server, according to an embodiment;

FIGS. 3 to 5 are diagrams for describing structures of a vehicle status information storage and a vehicle type information storage both equipped in a vehicle, and a comprehensive vehicle type information storage equipped in diagnostic equipment, according to an embodiment;

FIG. 6 is a flowchart for describing a method, performed by a management controller, of performing a primary evaluation of compliance with automotive regulations, according to an embodiment;

FIG. 7 is a flowchart for describing a method, performed by a management controller, of performing a primary evaluation of compliance with automotive regulations, according to another embodiment;

FIG. 8 is a flowchart for describing a method of managing secure software updates for compliance with automotive regulations, according to an embodiment;

FIG. 9 is a flowchart for describing a method of installing a public key for electronic signature in a controller, in the method of managing software updates of FIG. 8, according to an embodiment;

FIGS. 10A and 10B are flowcharts for describing a method of performing a software update, in the method of managing SW updates of FIG. 8, according to an embodiment;

FIG. 11 is a flowchart for describing a verification method of, at each startup, determining whether hardware versions or software versions of controllers are valid, in the method of managing software updates of FIG. 8, according to an embodiment;

FIG. 12 is a flowchart for describing a method of performing a software update, in the method of managing software updates of FIG. 8, according to another embodiment; and

FIG. 13 is a table showing a comparison between update management according to the present embodiment and update management according to the related art.

### DETAILED DESCRIPTION

Advantages and features of the present disclosure and a method for achieving them will be apparent with reference to embodiments of the present disclosure described below together with the accompanying drawings. The present disclosure may, however, be embodied in many different forms and should not be construed as being limited to the embodiments set forth herein, and all changes, equivalents, and substitutes that do not depart from the spirit and technical scope of the present disclosure are encompassed in the present disclosure. These embodiments are provided such that the present disclosure will be thorough and complete, and will fully convey the concept of the present disclosure to those of skill in the art. In describing the present disclosure, detailed explanations of the related art are omitted when it is deemed that they may unnecessarily obscure the gist of the present disclosure.

Terms used herein are for describing particular embodiments and are not intended to limit the scope of the present disclosure. The singular expression also includes the plural meaning as long as it does not inconsistent with the context. In the present specification, it is to be understood that the terms such as “including,” “having,” and “comprising” are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added. Terms such as “first” or “second” may be used to describe various elements, but the elements should not be limited by the terms. These terms are used only to distinguish one element from another.

In addition, as used herein, terms such as “ . . . er (or)”, “ . . . unit”, etc., denote a unit that performs at least one function or operation, which may be implemented as hardware or software or a combination thereof.

Hereinafter, embodiments of the present disclosure are described in detail with reference to the accompanying drawings, and the same or corresponding components are denoted by the same reference numerals when described with reference to the accompanying drawings, and thus, redundant descriptions thereof are omitted.

In the following embodiments, terms such as “first,” “second,” etc., are used only to distinguish one component from another, and such components must not be limited by these terms. In the following embodiments, the singular expression also includes the plural meaning as long as it is not inconsistent with the context.

In the following embodiments, the terms “comprise,” “include,” “have,” and the like specify the presence of stated features or components, but do not preclude the presence or addition of one or more other features or components.

When a certain embodiment may be differently implemented, particular operations may be performed differently from the sequence described herein. For example, two processes, which are successively described herein, may be substantially simultaneously performed, or may be performed in a process sequence opposite to a described process sequence.

Embodiments according to the present disclosure may aim to stably evaluate whether an individual vehicle is in compliance with automotive regulations, despite the following three complex aspects.

First, there may be complex relationships between automotive regulations and electronic control units (ECUs). A single vehicle may be equipped with about 100 ECUs, and each ECU may be associated with several regulatory items.

Second, even for the same vehicle model, different ECUs may be used depending on the selected options or the region where the regulations are applied. For example, even within the same vehicle model, the transmission may have various options such as manual, 8-speed automatic, or continuously variable transmission (CVT), and different ECUs may be installed according to each option. According to a vehicle type information storage DB_{vehicle type} where detailed information about a vehicle type is stored, each ECU may have multiple options, and each option may be matched with multiple pairs of hardware (HW) and software (SW) versions. These matched version pairs may constitute a compatibility group within a single option. These compatibility groups are configured differently depending on specific ECU options for the vehicle, and may provide important information for evaluating the regulatory compliance of the vehicle. In the present embodiment, the term ‘configuration’ may refer to an HW version of an ECU of a vehicle and an SW version installed on the corresponding HW.

Third, vehicle owners (drivers) may have different methods of replacing HW of ECUs or updating SW. This means that vehicles, even of the same model, may have different configurations, that is, different HW versions and SW versions.

Meanwhile, the concept of ‘vehicle type_regulation’ may clearly explain that even the same vehicle type may have various HW and SW versions according to different regulatory environments. Vehicle type_regulation may be defined as a combination of a vehicle type and a release region (a regulatory region). Even for the same vehicle type, regulations applied to vehicles may vary depending on the region they are exported to. For example, when the GV80 model is exported to the European and US markets, the HW versions and SW versions of ECUs required to meet the different emission regulations and safety standards of the respective markets may differ. In the following embodiments, a vehicle type may include vehicle type_regulation, and it may indicate how a specific vehicle type is configured according to the regulatory requirements of a specific region.

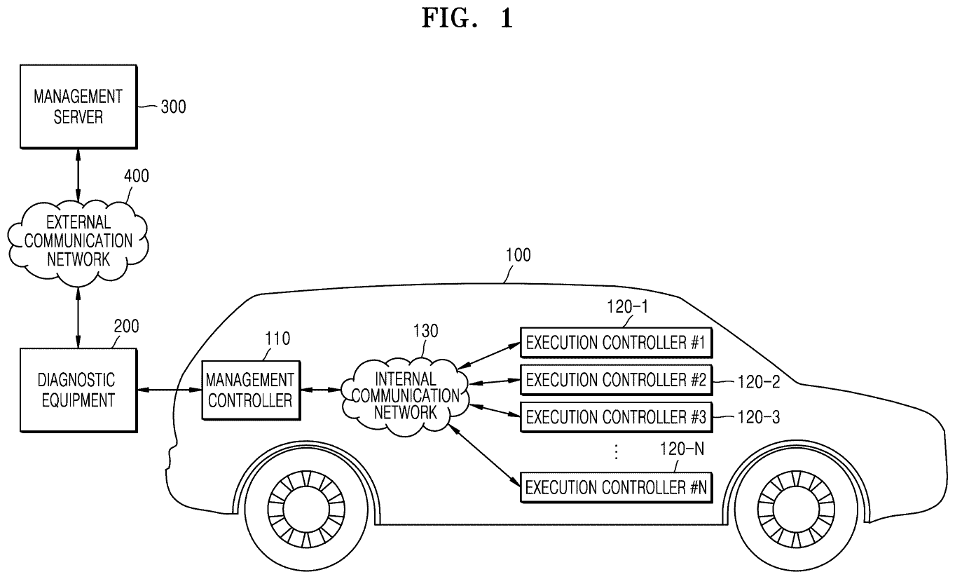

FIG. 1 is a diagram illustrating an example of an environment for managing secure SW updates for compliance with automotive regulations, according to an embodiment. Referring to FIG. 1, an environment for managing secure SW updates for compliance with automotive regulations according to an embodiment may include an individual vehicle 100 (hereinafter, referred to as a vehicle), diagnostic equipment 200, and a management server 300.

The vehicle 100 may include a management controller 110, execution controllers 120, and an internal communication network 130.

The management controller (110) may generate a primary determination result on whether the vehicle 100 is in compliance with automotive regulations, by comparing a vehicle type database DB_{vehicle type} that stores detailed information about the vehicle 100, and a vehicle status database DB_{vehicle status} that stores current configuration information about the vehicle 100 that is collected from the execution controllers 120. In the present embodiment, configuration information may include HW version information and SW version information about the management controller 110 and a plurality of execution controllers 120-1, 120-2, . . . , 120-N. In the present embodiment, the vehicle status database DB_{vehicle status} may include configuration information about the management controller 110 and the plurality of execution controllers 120-1, 120-2, . . . , 120-N. The management controller 110 may transmit the primary determination result to the diagnostic equipment 200 at a request from the diagnostic equipment 200.

In addition, the management controller 110 may install and update the vehicle type database DB_{vehicle type} at an explicit request from the diagnostic equipment 200. The management controller 110 may update an existing vehicle type database to a new vehicle type database by using the new vehicle type database included in an SW update package that is downloaded from the management server 300 via the diagnostic equipment 200, perform electronic signature verification on the updated new vehicle type database, and when the electronic signature verification is successful, generate and store an integrity verification code. In addition, the management controller 110 may update existing SW for a management controller to new SW by using the new SW included in the downloaded SW update package, perform electronic signature verification on the updated new SW, and when the electronic signature verification is successful, generate and store an integrity verification code.

In addition, the management controller 110 may verify, at each startup, whether the configuration information about the vehicle 100 is valid, through a result of performing integrity verification on the vehicle type database DB_{vehicle type}, and a result of comparing the vehicle type database DB_{vehicle type} with the vehicle status database DB_{vehicle status}. Here, that the configuration information is valid may include cases in which the integrity of the vehicle type database DB_{vehicle type} is successfully verified, and HW versions and SW versions are identical to each other when comparing the vehicle type database DB_{vehicle type} with the vehicle status database DB_{vehicle status}. Based on verifying that the configuration information about the vehicle 100 is valid, the management controller 110 may determine that the vehicle 100 is in compliance with the regulations, and record this determination in the vehicle status database DB_{vehicle status}. Based on verifying that the configuration information of the vehicle 100 is invalid, the management controller 110 may determine that the vehicle 100 is not in compliance with the regulations, and record this determination in the vehicle status database DB_{vehicle status}.

In the present embodiment, the management controller 110 may function as a central gateway (CGW). The management controller 110, while being a type of ECU, may function as a communication hub (e.g., a CGW), playing a key role in mediating and managing data between various networks within the vehicle 100. The management controller 110 may transmit, to the execution controllers 120, diagnostic signals or update signals received from an external source. The management controller 110 may, if necessary, perform a function of filtering and encrypting data being exchanged between networks.

The execution controllers 120 are ECUs and may include a plurality of execution controllers 120-1, 120-2, . . . , 120-N. In the present embodiment, the execution controllers 120 may include ECUs for controlling electrical components such as the vehicle's engine, transmission, airbags, steering system, as well as various sensors included in the vehicle 100. For example, from among the execution controllers 120, the execution controller #1 120-1 may include an engine control unit, the execution controller #2 120-2 may include an airbag control unit, and the execution controller #3 120-3 may include a convenience control unit.

Each of the plurality of execution controllers 120-1, 120-2, . . . , 120-N may be connected to the management controller 110 via the internal communication network 130. In the present embodiment, the internal communication network 130 may include an in-vehicle wired or wireless communication network such as controller area network (CAN), local interconnect network (LIN), Media-Oriented Systems Transport (MOST), or Ethernet.

The diagnostic equipment 200, provided in a repair shop, may communicate with the management controller 110 of the vehicle 100 to perform diagnostics and collect data. The diagnostic equipment 200 may diagnose and control the vehicle 100 by communicating with the management controller 110 of the vehicle 100 by using a standard protocol that is called Unified Diagnostic Services (UDS).

In the present embodiment, the diagnostic equipment 200 may compare versions of the vehicle type database DB_{vehicle type} collected from the vehicle 100, with versions of a master database DBₘₐₛₜₑᵣ that stores comprehensive information about all vehicle types. The diagnostic equipment 200 may generate a secondary determination result on whether the vehicle 100 is in compliance with the automotive regulations, based on a result of comparing the versions of the vehicle type database DB_{vehicle type} with the versions of the master database DBₘₐₛₜₑᵣ, and the primary determination result collected from the vehicle 100.

In addition, the diagnostic equipment 200 may generate a result of identifying a controller requiring an SW update by comparing the vehicle type database DB_{vehicle type} with the vehicle status database DB_{vehicle status}, and transmit the identification result to one or more of the management controller 110 or the plurality of execution controllers 120-1, 120-2, . . . , 120-N.

In addition, the diagnostic equipment 200 may retrieve results of new SW updates from the vehicle status database DB_{vehicle status} to confirm whether one or more of the management controller 110 or the plurality of execution controllers 120-1, 120-2, . . . , 120-N have completed the SW updates, and when the vehicle type database DB_{vehicle type} and the vehicle status database DB_{vehicle status} are identical to each other, terminate the SW updates. When terminating the SW updates, the diagnostic equipment 200 may request, when there are any violation logs stored in one or more of the management controller 110 or the plurality of execution controllers 120-1, 120-2, . . . , 120-N, deletion of the violation logs, and receive a result of deleting the violation logs.

The diagnostic equipment 200 may be connected to an electronic system of the vehicle 100 through an on-board diagnostics (OBD) port provided in the vehicle 100, to read diagnostic data, diagnose problems, and perform various vehicle management tasks.

In the present embodiment, in a case in which the vehicle 100 is a connectivity car, the diagnostic equipment 200 may be wirelessly connected to the connectivity car. The connectivity car may refer to a vehicle that is connected to the Internet and capable of over-the-air (OTA) updates. Instead of being physically connected to the diagnostic equipment 200 by using a traditional OBD port, the connectivity car may interact with the diagnostic equipment 200 via wireless communication. The diagnostic equipment 200 may remotely access data of the connectivity car to monitor the status of the vehicle in real time, and perform maintenance tasks such as SW updates remotely if necessary.

In the present embodiment, when the management controller 110 or the plurality of execution controllers 120-1, 120-2, . . . , 120-N are shipped, the management server 300 may generate pairs of public keys and private keys for electronic signature verification, extract the public keys, and distribute the public keys to the management controller 110 and the plurality of execution controllers 120-1, 120-2, . . . , 120-N. Here, the public key for electronic signature verification installed in each controller may be automatically installed in association with a controller production line and the management server 110 when the controller is shipped. Alternatively, according to another embodiment, the public key for electronic signature verification may be installed manually by a user.

The management server 300 may manage the master database DBₘₐₛₜₑᵣ up to date, and distribute the up-to-date master database DBₘₐₛₜₑᵣ to the diagnostic equipment 200. In addition, the management server 300 may generate latest versions of new SW for the management controller and new SW for the execution controller, and distribute them to the diagnostic equipment 200. The latest version of the master database DBₘₐₛₜₑᵣ, new SW for the management controller, and new SW for the execution controller may be included in an SW update package to be distributed to an SW update management unit 260 of the diagnostic equipment 200. Through this process, the management server 300 may individually generate a new SW package necessary for each controller.

An external communication network 400 may serve to connect the diagnostic equipment 200 to the management server 300. In a case in which the vehicle 100 is a connectivity car, the external communication network 400 may serve to connect the vehicle 100, the diagnostic equipment 200, and the management server 300 to each other. The external communication network 400 may include, for example, a wired network such as a local area network (LAN), a wide area network (WAN), a metropolitan area network (MAN), or an integrated services digital network (ISDN), or a wireless network such as a wireless LAN (WLAN), code-division multiple access (CDMA), or satellite communication, but the present disclosure is not limited thereto. In addition, the external communication network 400 may transmit and receive information by using short-range communication and/or long-range communication. Here, the short-range communication may include Bluetooth, radio-frequency identification (RFID), Infrared Data Association (IrDA), ultra-wideband (UWB), ZigBee, and wireless fidelity (Wi-Fi), and the long-range communication may include code-division multiple access (CDMA), frequency-division multiple access (FDMA), time-division multiple access (TDMA), orthogonal FDMA (OFDMA), and single-carrier FDMA (SC-FDMA).

The external communication network 400 may include connections of network elements such as hubs, bridges, routers, or switches. The external communication network 400 may include one or more connected networks, for example, a multi-network environment, including a public network, such as the Internet, and a private network, such as a secure corporate private network. Access to the external communication network 400 may be provided via one or more wired or wireless access networks.

Furthermore, the external communication network 400 may support controller area network (CAN) communication, vehicle-to-infrastructure (V2I) communication, vehicle-to-everything (V2X) communication, wireless access in vehicular environment (WAVE) communication, and an Internet-of-Things (IoT) network and/or 5G communication that allows distributed components, such as objects, to exchange and process information.

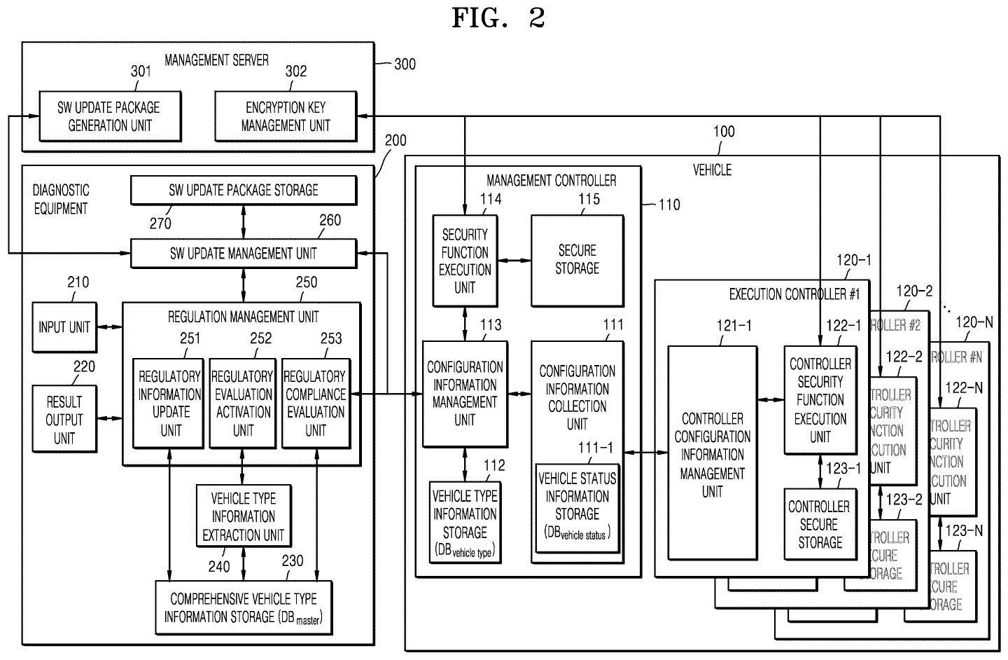

FIG. 2 is a block diagram schematically illustrating a configuration of a vehicle, diagnostic equipment, and a management server, according to an embodiment. In the following description, redundant descriptions provided above with reference to FIG. 1 will be omitted.

Referring to FIG. 2, the management controller 110 equipped in the vehicle 100 may include a configuration information collection unit 111, a vehicle type information storage 112, a configuration information management unit 113, a security function execution unit 114, and a secure storage 115. In addition, the execution controller 120 equipped in the vehicle 100 may include a controller configuration information management unit 121, a controller security function execution unit 122, and a controller secure storage 123.

Referring to FIG. 2, the diagnostic equipment 200 may include an input unit 210, a result output unit 220, a comprehensive vehicle type information storage 230, a vehicle type information extraction unit 240, a regulatory management unit 250, the SW update management unit 260, and an SW update package storage 270.

Referring to FIG. 2, the management server 300 may include an SW update package generation unit 301 and an encryption key management unit 302.

First, the management controller 110 will be described. The configuration information collection unit 111 may request configuration information (HW versions and SW versions) from the plurality of execution controllers 120-1, 120-2, . . . , 120-N. The configuration information collection unit 111 may collect configuration information from the plurality of execution controllers 120-1, 120-2, . . . , 120-N, and store the configuration information in a vehicle status information storage 111-1. The configuration information collection unit 111 may collect its own configuration information and store the configuration information in the vehicle status information storage 111-1. In the present embodiment, the vehicle status database DB_{vehicle status} may be used synonymously with the vehicle status information storage 111-1. In the present embodiment, at every startup of the vehicle 100 or periodically, the configuration information collection unit 111 may request configuration information from the plurality of execution controllers 120-1, 120-2, . . . , 120-N, and collect the configuration information from the plurality of execution controllers 120-1, 120-2, . . . , 120-N.

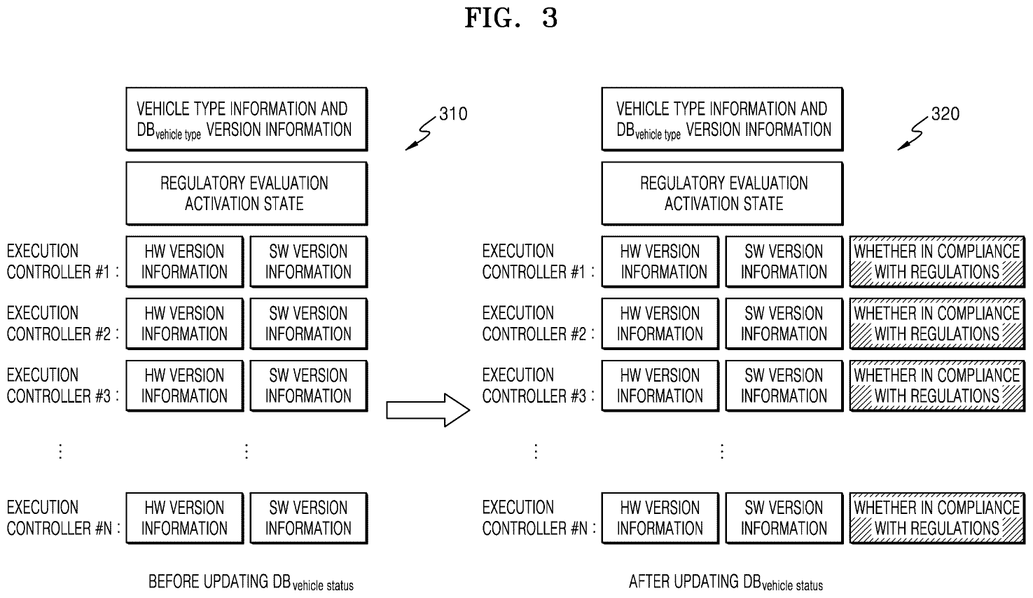

FIG. 3 is a diagram for describing a structure of a vehicle status information storage. Referring to FIG. 3, the vehicle status information storage 111-1 may store HW versions and SW versions of the plurality of execution controllers 120-1, 120-2, . . . , 120-N, reflecting the current status of the vehicle 100. The HW versions and SW versions stored in the vehicle status information storage 111-1 only reflect the current status and may not be separately updated information. In addition, when comparing the vehicle status information storage 111-1 before (310) and after (320) an update, a ‘log indicating whether in compliance with regulations’ may be additionally included after the update (320).

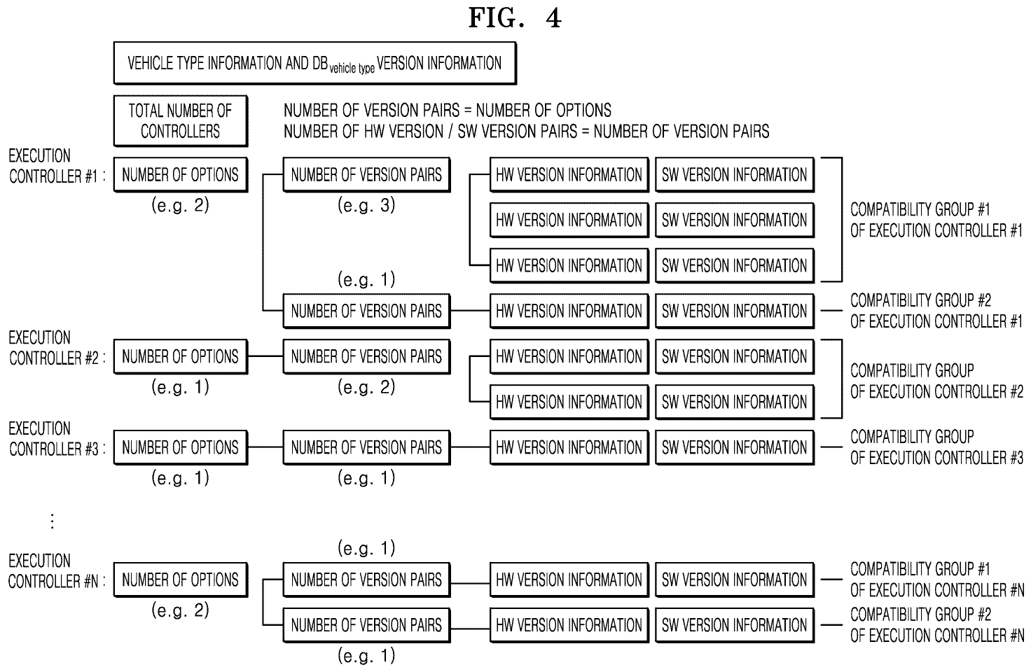

The vehicle type information storage 112 (DB_{vehicle type}) may store detailed vehicle type information about the vehicle type of the vehicle 100. In the present embodiment, the vehicle type database DB_{vehicle type} may be used synonymously with the vehicle type information storage 112. FIG. 4 is a diagram for describing a structure of the vehicle type information storage DB_{vehicle type}. Referring to FIG. 4, the vehicle type information storage 112 may store the number, name, individual option, option-specific version pair information, HW version information, SW version information, compatibility, etc. of the plurality of execution controllers 120-1, 120-2, . . . , 120-N, for the vehicle type of the vehicle 100.

In the present embodiment, when the diagnostic equipment 200 is connected to the vehicle 100, the vehicle type information storage 112 (DB_{vehicle type}) may be updated based on the comprehensive vehicle type information storage 230. Through the update, the vehicle type information storage 112 may store the latest vehicle type information. In a case of a connectivity car, the vehicle type information storage 112 (DB_{vehicle type}) may be updated periodically without connecting to the diagnostic equipment 200.

The configuration information management unit 113 may perform confirmation of automotive regulatory compliance of the vehicle 100, and may manage SW updates for the vehicle 100.

First, the configuration information management unit 113 performing confirmation of automotive regulatory compliance will be described. The configuration information management unit 113 may generate a primary determination result on whether the vehicle 100 is in compliance with automotive regulations, by comparing the vehicle type database DB_{vehicle type}, with the vehicle status database DB_{vehicle status} in which current configuration information about the plurality of execution controllers 120-1, 120-2, . . . , 120-N is stored.

When the vehicle type database DB_{vehicle type} and the vehicle status database DB_{vehicle status} are identical to each other, the configuration information management unit 113 may generate a 1-1st determination result indicating that the vehicle 100 is in compliance with the automotive regulations.

In the present embodiment, the configuration information management unit 113 may further generate detailed determination results for the 1-1st determination result as follows.

When the vehicle type database DB_{vehicle type} and the vehicle status database DB_{vehicle status} are identical to each other, and there are no additional update-required items in the vehicle status database DB_{vehicle status}, the configuration information management unit 113 may generate a 1-1-1st determination result indicating that the vehicle 100 is in compliance with the automotive regulations.

When the vehicle type database DB_{vehicle type} and the vehicle status database DB_{vehicle status} are identical to each other, and there are recommended additional update-required items in the vehicle status database DB_{vehicle status}, the configuration information management unit 113 may generate a 1-1-2nd determination result indicating that the vehicle 100 is in compliance with the automotive regulations.

When the vehicle type database DB_{vehicle type} and the vehicle status database DB_{vehicle status} are identical to each other, and there are mandatory additional update-required items in the vehicle status database DB_{vehicle status}, the configuration information management unit 113 may generate a 1-1-3rd determination result indicating that the vehicle 100 is not in compliance with the automotive regulations.

When the vehicle type database DB_{vehicle type} and the vehicle status database DB_{vehicle status} are different from each other, the configuration information management unit 113 may generate a 1-2nd determination result indicating that the vehicle 100 is not in compliance with the automotive regulations.

The configuration information management unit 113 may update and store, in the vehicle status information storage 111-1, a ‘log indicating whether in compliance with regulations’ based on the primary determination result. In the present embodiment, the configuration information management unit 113 may update and store, in the vehicle status information storage 111-1, the ‘log indicating whether in compliance with regulations’ including ‘compliance with regulations’ or ‘non-compliance with regulations’ corresponding to the 1-1st determination result (including the 1-1-1st to 1-1-3rd determination results) and the 1-2nd determination result. 320 of FIG. 3 illustrates the vehicle status information storage 111-1 (DB_{vehicle status}) after an update in which the ‘log indicating whether in compliance with regulations’ is recorded.

The generation of the primary determination result by the configuration information management unit 113 may be performed automatically at every startup or at an explicit request from the diagnostic equipment 200. Here, the ‘explicit request from the diagnostic equipment’ may include cases in which a request is made to determine whether configuration information about the vehicle is valid, through a user input or the like while the diagnostic equipment 200 is connected.

In a case of a connectivity car, assuming that the vehicle type information storage 112 is kept up to date, the primary determination by the configuration information management unit 113 may be the final determination.

Next, the configuration information management unit 113 performing SW update management will be described. The configuration information management unit 113 may receive, from the diagnostic equipment 200, a result of determining whether the vehicle type database DB_{vehicle type} needs to be updated. In the present embodiment, the diagnostic equipment 200 may compare versions of the master database DBₘₐₛₜₑᵣ with versions of the vehicle type database DB_{vehicle type}, determine, when the versions are different from each other, that the vehicle type database DB_{vehicle type} needs to be updated, and transmit this information to the configuration information management unit 113.

In response to receiving, from the diagnostic equipment 200, the information that the vehicle type database DB_{vehicle type} needs to be updated, the configuration information management unit 113 may update the existing vehicle type database DB_{vehicle type} to a new vehicle type database DB_{vehicle type} by using the new vehicle type database DB_{vehicle type} downloaded through the diagnostic equipment 200. Here, the new vehicle type database DB_{vehicle type} may have been generated by the diagnostic equipment 200 based on the master database DBₘₐₛₜₑᵣ. In addition, the configuration information management unit 113 described above may receive an electronic signature verification result on the updated new vehicle type database DB_{vehicle type}, from the security function execution unit 114 to be described below.

The configuration information management unit 113 may collect results of identifying a controller that requires an SW update, from the diagnostic equipment 200. In the present embodiment, the diagnostic equipment 200 may compare the updated vehicle type database DB_{vehicle type} with the vehicle status database DB_{vehicle status}, and when they are different from each other, generate a result of identifying a controller that requires an SW update, and transmit the result to the configuration information management unit 113. In more detail, when it is determined, by comparing the updated vehicle type database DB_{vehicle type} with the vehicle status database DB_{vehicle status}, that the management controller 110 has different SW version information, the diagnostic equipment 200 may generate an identification result indicating that an SW update of the management controller 110 is required, and transmit the identification result to the configuration information management unit 113. When it is determined, by comparing the updated vehicle type database DB_{vehicle type} with the vehicle status database DB_{vehicle status}, that one or more of the plurality of execution controllers 120-1, 120-2, . . . , 120-N have different SW version information, the diagnostic equipment 200 may generate an identification result indicating that SW updates of the corresponding execution controllers 120 are required, and transmit the identification result to the controller configuration information management units 121 of the one or more of execution controllers 120-1, 120-2, . . . , 120-N.

When the configuration information management unit 113 determines, based on the identification result, that an SW update of the management controller 110 is required, the configuration information management unit 113 may update the existing SW for the management controller to new SW by using the new SW for the management controller that is downloaded from the management server 300 via the diagnostic equipment 200. When a new SW update is performed, the security function execution unit 114 may perform electronic signature verification on the updated new SW for the management controller, and when the verification is successful, generate an integrity verification code and store it in the secure storage 115.

In response to an explicit request for the vehicle status database DB_{vehicle status} from the diagnostic equipment 200, the configuration information management unit 113 may request configuration information from one or more of the plurality of execution controllers 120-1, 120-2, . . . , 120-N. The configuration information management unit 113 may obtain, from one or more of the plurality of execution controllers 120-1, 120-2, . . . , 120-N, configuration information responses to the configuration information request. The configuration information management unit 113 may update the vehicle status database DB_{vehicle status} based on configuration information about the management controller 110, and the configuration information about one or more of the plurality of execution controllers 120-1, 120-2, . . . , 120-N. That is, the configuration information management unit 113 may update the vehicle status database DB_{vehicle status} to reflect a result of the new SW update for the management controller and a result of the new SW update for the execution controller. The updated vehicle status database DB_{vehicle status} may be transmitted to the diagnostic equipment 200 in response to an explicit request for the vehicle status database DB_{vehicle status}.

The configuration information management unit 113 may collect an SW update termination signal from the diagnostic equipment 200. When one or more SW updates in the management controller 110 or one or more of the plurality of execution controllers 120-1, 120-2, . . . , 120-N are completed, and it is determined that the vehicle type database DB_{vehicle type} and the vehicle status database DB_{vehicle status} are identical to each other, the diagnostic equipment 200 may generate an SW update termination signal and transmit the SW update termination signal to the configuration information management unit 113.

After receiving, from the diagnostic equipment 200, a request for deletion of violation logs due to termination of an SW update, the configuration information management unit 113 may search the secure storage 115 to be described below, and when there is a violation log stored in the secure storage 115, delete the stored violation log.

The configuration information management unit 113 may verify whether HW versions and SW versions are valid, at every startup of the vehicle 100. To this end, the configuration information management unit 113 may receive, from the security function execution unit 114, an integrity verification result on the vehicle type database DB_{vehicle type}.

When the configuration information management unit 113 successfully performs integrity verification on the vehicle type database DB_{vehicle type}, the configuration information management unit 113 may perform validation on the vehicle status database DB_{vehicle status} by comparing the vehicle type database DB_{vehicle type} with the vehicle status database DB_{vehicle status}. The configuration information management unit 113 may perform first validation to determine whether HW versions are identical to each other, by comparing the vehicle type database DB_{vehicle type} with the vehicle status database DB_{vehicle status}. The configuration information management unit 113 may perform second validation to determine whether SW versions are identical to each other, by comparing the vehicle type database DB_{vehicle type} with the vehicle status database DB_{vehicle status}. The configuration information management unit 113 may perform third validation to determine whether there is an SW integrity violation log pre-stored in the secure storage 115. In the present embodiment, the configuration information management unit 113 may add, to the third validation, confirmation of the presence or absence of an SW integrity violation log collected from the plurality of execution controllers 120-1, 120-2, . . . , 120-N. The plurality of execution controllers 120-1, 120-2, . . . , 120-N may transmit, to the configuration information management unit 113, information indicating the presence or absence of an SW integrity violation log pre-stored in their controller secure storages 123.

When the validation of the vehicle status database DB_{vehicle status} has been successfully performed, the configuration information management unit 113 may determine that the vehicle 100 is in compliance with the automotive regulations. Based on determining that the HW versions are identical to each other, that the SW versions are identical to each other, that there are no pre-stored SW integrity violation logs, and thus, that the validation has been successfully performed, the configuration information management unit 113 may store, in the vehicle status database DB_{vehicle status}, information that the vehicle 100 is in compliance with the automotive regulations.

When a violation has occurred in the validation of the vehicle status database DB_{vehicle status}, the configuration information management unit 113 may determine that the vehicle 100 is not in compliance with the automotive regulations. Based on determining that the HW versions are different from each other, the SW versions are different from each other, or there are a pre-stored SW integrity violation log, and thus, that a violation has occurred in the validation, the configuration information management unit 113 may store, in the vehicle status database DB_{vehicle status}, information that the vehicle 100 is not in compliance with the automotive regulations.

The configuration information management unit 113 may repeatedly receive a result of integrity verification on SW, from the security function execution unit 114, at an initial bootup or in a real-time operation. Based on receiving, from the security function execution unit 114, information that a violation has occurred in the integrity verification, the configuration information management unit 113 may generate a first integrity violation log and store it in the secure storage 115. In the present embodiment, the security function execution unit 114 may generate a first integrity violation log and store it in the secure storage 115.

The configuration information management unit 113 may repeatedly receive results of integrity verification on SW from the plurality of execution controllers 120-1, 120-2, . . . , 120-N, at an initial bootup or in a real-time operation. The configuration information management unit 113 may receive second integrity violation logs from the plurality of execution controllers 120-1, 120-2, . . . , 120-N.

The configuration information management unit 113 may perform third validation on the first integrity violation log and the second integrity violation log.

The security function execution unit 114 may receive a public key for electronic signature verification that has been distributed from the management server 300 at the time of shipment of the management controller 110, and store the public key in the secure storage 115.

As the existing vehicle type database DB_{vehicle type} is updated to a new vehicle type database DB_{vehicle type}, the security function execution unit 114 may perform electronic signature verification of the updated new vehicle type database DB_{vehicle type} by using the public key for electronic signature verification. In addition, in response to the electronic signature verification being successful, the security function execution unit 114 may generate an integrity verification code MAC_{ref} and store it in the secure storage 115. Here, before generating the integrity verification code MAC_{ref}, the security function execution unit 114 may generate a symmetric key MAC_{key} for the vehicle type database DB_{vehicle type} to be used to generate an integrity verification code during the update process for the new vehicle type database DB_{vehicle type}.

The security function execution unit 114 may perform integrity verification to verify whether the vehicle type database DB_{vehicle type} has been tampered with, by using the integrity verification code. The security function execution unit 114 may calculate an integrity verification calculation value MAC_{calc} of the vehicle type database DB_{vehicle type} at every startup of the vehicle, and compare the integrity verification calculation value MAC_{calc} with the integrity verification code MAC_{ref} to verify whether the vehicle type database DB_{vehicle type} has been tampered with.

As existing SW for the management controller is updated to new SW, the security function execution unit 114 may perform electronic signature verification on the updated new SW by using a public key for electronic signature verification. In addition, in response to the electronic signature verification being successful, the security function execution unit 114 may generate an integrity verification code MAC_{ref} for the management controller and store it in the secure storage 115. Here, before generating the integrity verification code MAC_{ref}, the security function execution unit 114 may generate a symmetric key MAC_{key} for the management controller to be used to generate an integrity verification code during the update process for the new SW for the management controller.

In addition, the security function execution unit 114 may perform integrity verification to verify whether the SW for the management controller has been tampered with, by using the integrity verification code MAC_{ref}. The security function execution unit 114 may calculate an integrity verification calculation value MAC_{calc} of the SW for the management controller by using the symmetric key MAC_{key}, and compare the integrity verification calculation value MAC_{calc} with the integrity verification code MAC_{ref} to verify whether the SW for the management controller has been tampered with, at an initial bootup of the management controller 110 or in real time. When the security function execution unit 114 fails to verify the integrity of the SW for the management controller, the security function execution unit 114 may generate a violation log and store it in the secure storage 115.

In the present embodiment, the functions performed by the configuration information collection unit 111, the configuration information management unit 113, and the security function execution unit 114 that are included in the management controller 110 may be performed by a processor (not shown). That is, the function of the management controller 110 may be performed by the processor. In addition, information stored in the vehicle status information storage 111-1 (DB_{vehicle status}), the vehicle type information storage 112 (DB_{vehicle type}) and the secure storage 115 may be stored in a memory (not shown). The memory may be operatively connected to the processor and may store at least one piece of code associated with an operation performed by the processor.

Next, the execution controllers 120 will be described. The controller configuration information management unit 121 may receive, from the diagnostic equipment 200, a result of determining that an SW update is required. The controller configuration information management unit 121 may update the existing SW for the execution controller with new SW by using the new SW for the execution controller obtained through the diagnostic equipment 200. When a new SW update is performed, the security function execution unit 114 may perform electronic signature verification on the updated new SW for the execution controller, and when the verification is successful, generate an integrity verification code and store it in the controller secure storage 123.

The controller security function execution unit 122 may receive public keys for electronic signature verification that has been distributed from the management server 300 at the time of shipment of the management controller 110 and the plurality of execution controllers 120-1, 120-2, . . . , 120-N, and store the public keys in the controller secure storage 123.

The controller security function execution unit 122 may perform electronic signature verification on the new SW for the execution controller by using the public key for electronic signature verification, and when the electronic signature verification is successful, generate an integrity verification code MAC_{ref} and store it in the controller secure storage 123. Here, before generating the integrity verification code MAC_{ref}, the controller security function execution unit 122 may generate a symmetric key MAC_{key} for the execution controller to be used to generate an integrity verification code during the update process for the SW for the execution controller.

The controller security function execution unit 122 may perform integrity verification to verify whether the SW for the execution controller has been tampered with, by using the integrity verification code MAC_{ref}. The controller security function execution unit 122 may calculate an integrity verification calculation value MAC_{calc} of the SW for the execution controller by using the symmetric key MAC_{key}, and compare the integrity verification calculation value MAC_{calc} with the integrity verification code MAC_{ref} to verify whether the SW for the execution controller has been tampered with, at an initial bootup of the execution controller 120 of the vehicle or in each real-time operation. When the controller security function execution unit 122 fails to verify the integrity of the SW for the execution controller, the controller security function execution unit 122 may generate a violation log and store it in the controller secure storage 123.

Next, the diagnostic equipment 200 will be described. The input unit 210 may function as an interface that receives data for evaluating whether the vehicle is in compliance with automotive regulations. The input unit 210 may function as an interface that receives data for managing SW updates. A user may input a command to evaluate whether the vehicle is in compliance with automotive regulations or an SW update command, through the input unit 210. For example, when the regulatory management unit 250 performs a regulatory information update, the input unit 210 may receive, as input data, data stored in the latest version of the comprehensive vehicle type information storage 230 (DBₘₐₛₜₑᵣ). In addition, when the regulatory management unit 250 activates a regulatory evaluation, the input unit 210 may scan a barcode of the vehicle 100 and process, as input data, information about a vehicle type/release region obtained from the barcode.

The result output unit 220 may output a result of an input function to be performed. For example, the result output unit 220 may output a result of evaluating whether the vehicle is in compliance with automotive regulations. In addition, the result output unit 220 may output a result of an SW update.

As the vehicle 100 is in compliance with the regulations, the result output unit 220 may display details of the regulations that the vehicle is in compliance with, and overall configuration information (e.g., HW versions, SW versions, compatibility groups, version pairs, etc.) about the plurality of execution controllers 120-1, 120-2, . . . , 120-N. In addition, when there are additional update items that are not required but recommended, the result output unit 220 may display relevant details to the user.

As the vehicle 100 is not in compliance with the regulations, the result output unit 220 may display details of the regulations that the vehicles is not in compliance with.

In addition, the result output unit 220 may display an identifier for identifying the vehicle 100. For example, the identifier may include a vehicle identification number (VIN), which may also be used for tracing individual vehicle-level configuration information. In addition, the result output unit 220 may display information about the name and version of the vehicle type information storage 112 (DB_{vehicle type}) installed in the vehicle 100.

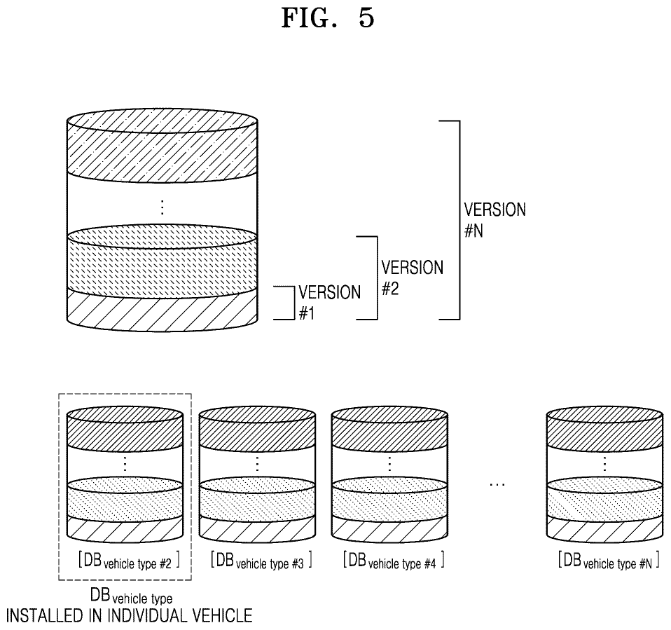

The comprehensive vehicle type information storage 230 may include a cumulative and integrated database of vehicle types that are managed by vehicle manufacturers. In the present embodiment, the master database DBₘₐₛₜₑᵣ may be used synonymously with the comprehensive vehicle type information storage 230. FIG. 5 is a diagram for describing a structure of the comprehensive vehicle type information storage 230. Referring to FIG. 5, detailed information of respective vehicle types DB_{vehicle type #1}, DB_{vehicle type #2}, DB_{vehicle type #3}, . . . , DB_{vehicle type #N} may be stored in the comprehensive vehicle type information storage 230. For example, the comprehensive vehicle type information storage 230 may store detailed information about each vehicle type, regulations and options for the vehicle type, and all HW and SW version information applicable to the vehicle type. The diagnostic equipment 200 may collectively manage all vehicle types and individual vehicles of various versions operating in the field, by utilizing the comprehensive vehicle type information storage 230. The diagnostic equipment 200 may download the comprehensive vehicle type information storage 230 from a management server (not shown).

The vehicle type information extraction unit 240 may extract, from the comprehensive vehicle type information storage 230, the vehicle type database DB_{vehicle type} (e.g., DB_{vehicle type #2}) for the vehicle 100 to which the diagnostic equipment 200 is connected.

The regulatory management unit 250 may include a regulatory information update unit 251, a regulatory evaluation activation unit 252, and a regulatory compliance evaluation unit 253.

When a new vehicle type is added or when the certification of an existing vehicle type is renewed, the regulatory information update unit 251 may update the comprehensive vehicle type information storage 230 to the latest status. The diagnostic equipment 200 may communicate with the management server to perform an update on the comprehensive vehicle type information storage 230. Accordingly, the vehicle type database DB_{vehicle type} of the vehicle 100 extracted by the vehicle type information extraction unit 240 from the comprehensive vehicle type information storage 230 may be the latest vehicle type database DB_{vehicle type}.

The regulatory evaluation activation unit 252 may confirm, on the vehicle 100 to which the diagnostic equipment 200 is connected, whether a regulatory evaluation function is installed and activated at an end-of-line (EOL) stage, i.e., before the shipment of the vehicle 100. During the EOL stage in the vehicle production process, the vehicle type database DB_{vehicle type} extracted from the vehicle type information extraction unit 240 may be installed in the vehicle 100 for the first time. When the vehicle type database DB_{vehicle type} is initially installed in the vehicle 100, the regulatory evaluation function may also be installed and activated. The regulatory evaluation activation unit 252 may perform an inspection to identify vehicles that do not have installed therein regulatory evaluation functions due to errors that may occur during a production process, and confirm whether all vehicles are shipped with appropriate regulatory compliance functions.

The regulatory compliance evaluation unit 253 may generate a secondary determination result on whether the vehicle 100 is in compliance with automotive regulations.

To generate the secondary determination result, the regulatory compliance evaluation unit 253 may collect, from the management controller 110, versions of the vehicle type database DB_{vehicle type} for the vehicle 100. In addition, the regulatory compliance evaluation unit 253 may extract versions of the master database DBₘₐₛₜₑᵣ that stores comprehensive information about all vehicle types. In addition, the regulatory compliance evaluation unit 253 may receive, from the management controller 110, a primary determination result on whether the vehicle 100 is in compliance with automotive regulations.

The regulatory compliance evaluation unit 253 may generate a secondary determination result on whether the vehicle 100 is in compliance with the automotive regulations, based on the primary determination result and a result of determining whether versions of the vehicle type database DB_{vehicle type} and versions of the master database DBₘₐₛₜₑᵣ are identical to each other.

In the present embodiment, the versions of the master database DBₘₐₛₜₑᵣ may include versions of the vehicle type database for the vehicle 100 stored in the master database DBₘₐₛₜₑᵣ (DB_{vehicle type} in DBₘₐₛₜₑᵣ). Thus, comparing the versions of the vehicle type database DB_{vehicle type} with the versions of the master database DBₘₐₛₜₑᵣ may have the same meaning as comparing the versions of the vehicle type database DB_{vehicle type} with the versions of the vehicle type database stored in the master database DBₘₐₛₜₑᵣ (DB_{vehicle type} in DBₘₐₛₜₑᵣ).

When the versions of the vehicle type database DB_{vehicle type} and the versions of the master database DBₘₐₛₜₑᵣ are identical to each other, the regulatory compliance evaluation unit 253 may determine the primary determination result as a 2-1st determination result.

The regulatory compliance evaluation unit 253 may further generate detailed determination results for the 2-1st determination result as follows.

In response to a determination result that the versions of the vehicle type database DB vehicle type and the versions of the master database DBₘₐₛₜₑᵣ are identical to each other, and a primary determination result that the vehicle 100 is in compliance with the automotive regulations, the regulatory compliance evaluation unit 253 may generate a 2-1-1st determination result that the vehicle 100 is in compliance with the automotive regulations.

In response to a determination result that the versions of the vehicle type database DB vehicle type and the versions of the master database DBₘₐₛₜₑᵣ are identical to each other, and a primary determination result that the vehicle 100 is not in compliance with the automotive regulations, the regulatory compliance evaluation unit 253 may generate a 2-1-1st determination result that the vehicle 100 is not in compliance with the automotive regulations.

When the versions of the vehicle type database DB_{vehicle type} and the master database DBₘₐₛₜₑᵣ are different from each other, and the master database DBₘₐₛₜₑᵣ is a recommended update item, the regulatory compliance evaluation unit 253 may generate the primary determination result as a 2-2nd determination result.

The regulatory compliance evaluation unit 253 may further generate detailed determination results for the 2-2nd determination result as follows.

In response to a determination result that the versions of the vehicle type database DB vehicle type and the master database DBₘₐₛₜₑᵣ are different from each other, and that the master database DBₘₐₛₜₑᵣ is recommended to be updated, and a primary determination result that the vehicle 100 is in compliance with the automotive regulations, the regulatory compliance evaluation unit 253 may generate a 2-2-1st determination result that the vehicle 100 is in compliance with the automotive regulations. Here, the regulatory compliance evaluation unit 253 may output the 2-2-1st determination result, and information that there is an optional update item.

In response to a determination result that the versions of the vehicle type database DB vehicle type and the master database DBₘₐₛₜₑᵣ are different from each other, and that the master database DBₘₐₛₜₑᵣ is recommended to be updated, and a primary determination result that the vehicle 100 is not in compliance with the automotive regulations, the regulatory compliance evaluation unit 253 may generate a 2-2-2nd determination result that the vehicle 100 is not in compliance with the automotive regulations.

In response to a determination result that the versions of the vehicle type database DB vehicle type and the versions of the master database DBₘₐₛₜₑᵣ are different from each other and that the master database DBₘₐₛₜₑᵣ is a mandatory update item, the regulatory compliance evaluation unit 253 may generate a 2-3rd determination result that the vehicle 100 is not in compliance with the automotive regulations. Here, the regulatory compliance evaluation unit 253 may transmit, to the configuration information management unit 113, the vehicle type database for the vehicle 100 extracted from the master database DBₘₐₛₜₑᵣ (DB_{vehicle type} in DBₘₐₛₜₑᵣ), along with a command to update the vehicle type database DB_{vehicle type}.

The SW update management unit 260 may receive an SW update package transmitted from the management server 300 and store the SW update package in the SW update package storage 270. The SW update management unit 260 may manage the management controller 110 to update the existing vehicle type database DB_{vehicle type} to a new vehicle type database DB_{vehicle type}. The SW update management unit 260 may compare the new vehicle type database DB_{vehicle type} that is generated based on the master database DBₘₐₛₜₑᵣ, with the existing vehicle type database DB_{vehicle type}, and, when they are different from each other, generate a result indicating that the vehicle type database DB_{vehicle type} is required to be updated, and transmits the result to the management controller 110. In response to receiving the result, the management controller 110 may update the existing vehicle type database DB_{vehicle type} to the new vehicle type database DB_{vehicle type}, and perform electronic signature verification on the updated new vehicle type database DB_{vehicle type}. In addition, when the electronic signature verification is successful, the management controller 110 may generate and store an integrity verification code.

The SW update management unit 260 may compare the updated vehicle type database DB_{vehicle type} with the vehicle status database DB_{vehicle status} to generate a result of identifying a controller that requires an SW update, and transmit the identification result to the management controller 110 or one or more of the plurality of execution controllers 120-1, 120-2, . . . , 120-N.

When the vehicle type database DB_{vehicle type} and the vehicle status database DB_{vehicle status} are identical to each other, and there is a recommended additional update-required item in the vehicle status database DB_{vehicle status}, the SW update management unit 260 may generate a controller identification result for a controller that requires an SW update, from a determination result that the vehicle 100 is in compliance with the automotive regulations. The SW update management unit 260 may transmit the controller identification result to the management controller 110 or one or more of the plurality of execution controllers 120-1, 120-2, . . . , 120-N.

When the vehicle type database DB_{vehicle type} and the vehicle status database DB_{vehicle status} are identical to each other, and there is a mandatory additional update-required item in the vehicle status database DB_{vehicle status}, the SW update management unit 260 may generate a controller identification result for a controller that requires an SW update, from a determination result that the vehicle 100 is not in compliance with the automotive regulations. The SW update management unit 260 may transmit the controller identification result to the management controller 110 or one or more of the plurality of execution controllers 120-1, 120-2, . . . , 120-N.

The SW update management unit 260 may completely perform, at least once, an SW update for the configuration information management unit 113 or a plurality of controller configuration information management units 121, and when the vehicle type database DB_{vehicle type} and the vehicle status database DB_{vehicle status} are identical to each other, determine to terminate the SW update and transmit a request for deletion of violation logs, to the management controller 110 or one or more of the plurality of execution controllers 120-1, 120-2, . . . , 120-N.

Finally, the management server 300 will be described. The SW update package generation unit 301 may manage the master database DBₘₐₛₜₑᵣ up to date, and distribute the up-to-date master database DBₘₐₛₜₑᵣ to the diagnostic equipment 200. In addition, the management server 300 may generate latest versions of new SW for the management controller and new SW for the execution controller, and distribute them to the diagnostic equipment 200. The latest version of the master database DBₘₐₛₜₑᵣ, new SW for the management controller, and new SW for the execution controller may be included in an SW update package to be distributed to an SW update management unit 260 of the diagnostic equipment 200. Through this process, the SW update package generation unit 301 may individually generate a new SW package necessary for each controller.

The encryption key management unit 302 may generate a pair of a public key and a private key for electronic signature verification, and distribute the public key to the management controller 110 and the plurality of execution controllers 120-1, 120-2, . . . , 120-N at the time of shipment of when the controllers.

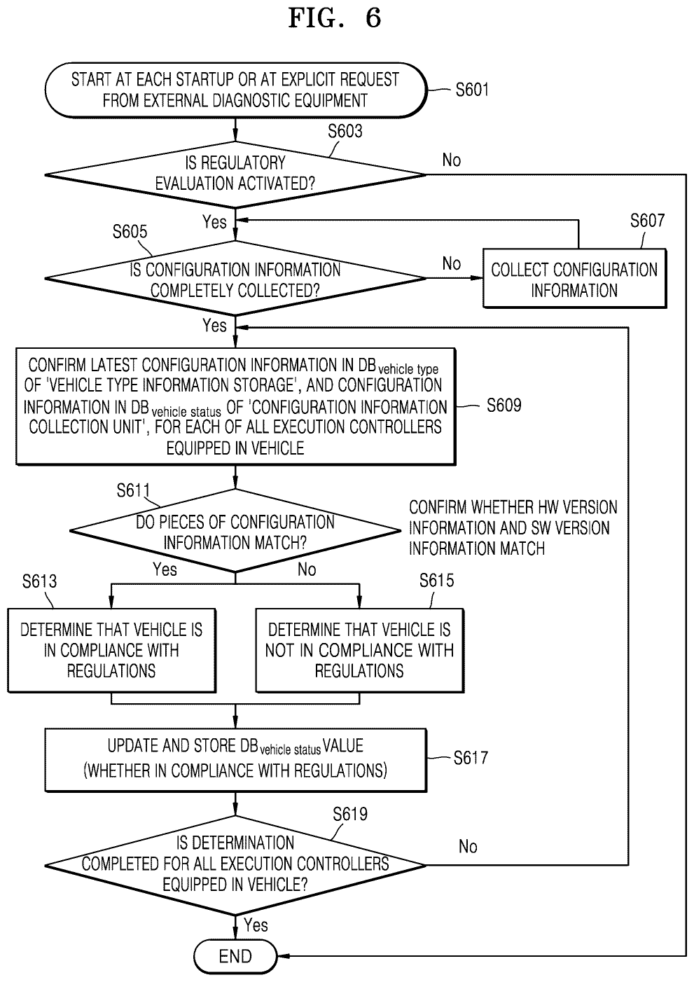

FIG. 6 is a flowchart for describing a method, performed by a management controller, of performing a primary evaluation of compliance with automotive regulations, according to an embodiment. In the following description, redundant descriptions provided above with reference to FIGS. 1 to 5 will be omitted. The method of performing a primary evaluation of compliance with automotive regulations according to the present embodiment will be described assuming that the method is performed by the management controller 110.

Referring to FIG. 6, in operation S601, the management controller 110 may start a primary evaluation of whether the vehicle 100 is in compliance with automotive regulations, at each startup of the vehicle 100 or at an explicit request from the external diagnostic equipment 200.

In operation S603, the management controller 110 may confirm whether a regulatory evaluation function is installed and activated in the vehicle type information storage 112.

In operations S605 and S607, when it determines that the regulatory evaluation function is installed and activated, the management controller 110 may collect the vehicle status database DB_{vehicle status} from the plurality of execution controllers 120-1, 120-2, . . . , 120-N. Here, configuration information including HW versions and SW versions may be stored in the vehicle status database DB_{vehicle status}.

In operations S609 and S611, for each of the plurality of execution controllers 120-1, 120-2, . . . , 120-N, the management controller 110 may determine whether the vehicle type database DB_{vehicle type} and the vehicle status database DB_{vehicle status} are identical to each other, by comparing the vehicle type database DB_{vehicle type} with the vehicle status database DB_{vehicle status}.

In operation S613, when the vehicle type database DB_{vehicle type} and the vehicle status database DB_{vehicle status} are identical to each other, the management controller 110 may determine that the vehicle 100 is in compliance with the automotive regulations (1-1st determination). When HW versions and SW versions stored in the vehicle type database DB_{vehicle type} and current HW versions and SW versions stored in the vehicle status database DB_{vehicle status} are identical to each other, the management controller 110 may determine that the vehicle 100 is in compliance with the automotive regulations.

In operation S615, when the vehicle type database DB_{vehicle type} and the vehicle status database DB_{vehicle status} are different from each other, the management controller 110 may determine that the vehicle 100 is not in compliance with the automotive regulations (1-2nd determination). When HW versions and SW versions stored in the vehicle type database DB_{vehicle type} and current HW versions and SW versions stored in the vehicle status database DB_{vehicle status} are different from each other, the management controller 110 may determine that the vehicle 100 is not in compliance with the automotive regulations.

In operation S617, the management controller 110 may update and store, in the vehicle status information storage 111-1, a ‘log indicating whether in compliance with regulations’ including ‘compliance with regulations’ or ‘non-compliance with regulations’ as a determination result.

In operation S619, when the determination is completed for the plurality of execution controllers 120-1, 120-2, . . . , 120-N, the management controller 110 may terminate the primary evaluation of whether the vehicle is in compliance with the automotive regulations.

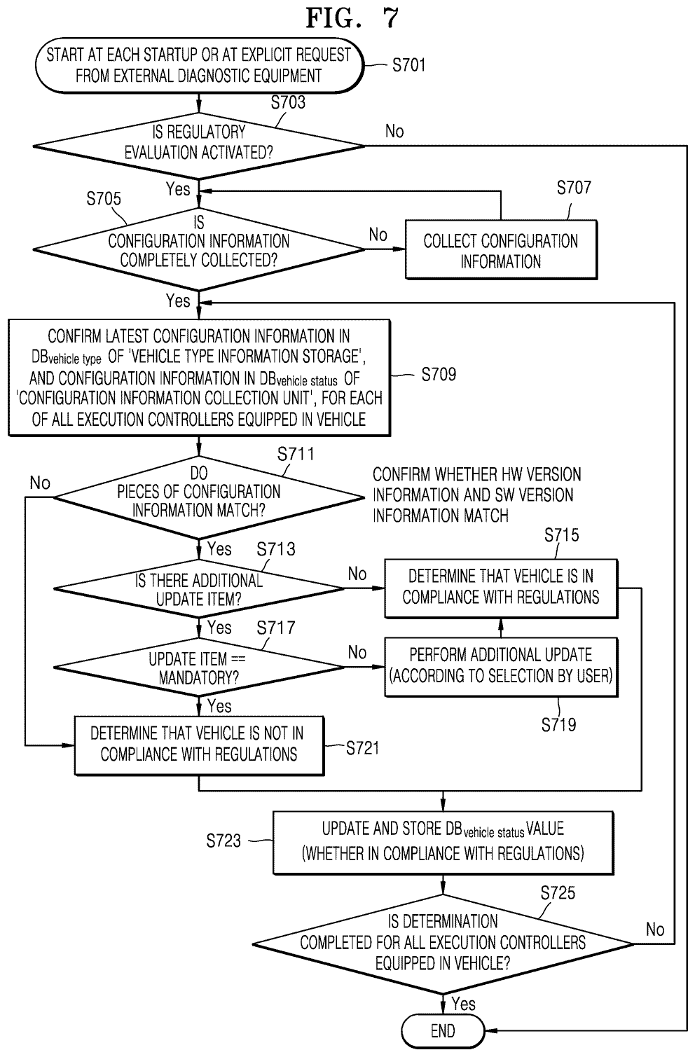

FIG. 7 is a flowchart for describing a method, performed by a management controller, of performing a primary evaluation of compliance with automotive regulations, according to another embodiment. In the following description, redundant descriptions provided above with reference to FIGS. 1 to 6 will be omitted. The method of performing a primary evaluation of compliance with automotive regulations according to the present embodiment will be described assuming that the method is performed by the management controller 110.

Referring to FIG. 7, in operation S701, the management controller 110 may start a primary evaluation of whether the vehicle 100 is in compliance with automotive regulations, at each startup of the vehicle 100 or at an explicit request from the external diagnostic equipment 200.

In operation S703, the management controller 110 may confirm whether a regulatory evaluation function is installed and activated in the vehicle type information storage 112.

In operations S705 and S707, when it determines that the regulatory evaluation function is installed and activated, the management controller 110 may collect the vehicle status database DB_{vehicle status} from the plurality of execution controllers 120-1, 120-2, . . . , 120-N.

In operations S709 and S711, for each of the plurality of execution controllers 120-1, 120-2, . . . , 120-N, the management controller 110 may determine whether the vehicle type database DB_{vehicle type} and the vehicle status database DB_{vehicle status} are identical to each other, by comparing the vehicle type database DB_{vehicle type} with the vehicle status database DB_{vehicle status}. When the vehicle type database DB_{vehicle type} and the vehicle status database DB_{vehicle status} are different from each other, the management controller 110 may determine that the vehicle 100 is not in compliance with the automotive regulations (1-2nd determination) (operation S721).

In operation S713, when the vehicle type database DB_{vehicle type} and the vehicle status database DB_{vehicle status} are identical to each other, the management controller 110 may determine whether there is an additional update item for an SW version included in the vehicle status database DB_{vehicle status}.

In operation S715, when the vehicle type database DB_{vehicle type} and the vehicle status database DB_{vehicle status} are identical to each other, and there are no additional update items for the SW versions included in the vehicle status database DB_{vehicle status}, the management controller 110 may determine that the vehicle 100 is in compliance with the automotive regulations (1-1-1st determination). Here, that there are no additional update items may mean that the SW versions included in the vehicle status database DB_{vehicle status} are the latest SW versions.

In operation S717, when the vehicle type database DB_{vehicle type} and the vehicle status database DB_{vehicle status} are identical to each other, and there is an additional update item for an SW version included in the vehicle status database DB_{vehicle status}, the management controller 110 may determine whether the additional update item is a mandatory update item.

In operation S719, when the vehicle type database DB_{vehicle type} and the vehicle status database DB_{vehicle status} are identical to each other, and there is an additional update item for an SW version included in the vehicle status database DB_{vehicle status}, and the additional update item is a recommended update item, the management controller 110 may determine that the vehicle 100 is in compliance with the automotive regulations (1-1-2nd determination). At this time, the management controller 110 may perform the additional update of the corresponding SW version in response to a selection by the user.

In operation S721, when the vehicle type database DB_{vehicle type} and the vehicle status database DB_{vehicle status} are identical to each other, and there is an additional update item for an SW version included in the vehicle status database DB_{vehicle status}, and the additional update item is a mandatory update item, the management controller 110 may determine that the vehicle 100 is not in compliance with the automotive regulations (1-1-3rd determination).

In operation S723, the management controller 110 may update and store, in the vehicle status information storage 111-1, a ‘log indicating whether in compliance with regulations’ including ‘compliance with regulations’ or ‘non-compliance with regulations’ as a determination result. In the present embodiment, the ‘log indicating whether in compliance with regulations’ may include ‘compliance with regulations’ or ‘non-compliance with regulations’ for each of the plurality of execution controllers 120-1, 120-2, . . . , 120-N.

In operation 725, when the determination is completed for the plurality of execution controllers 120-1, 120-2, . . . , 120-N, the management controller 110 may terminate the primary evaluation of whether the vehicle is in compliance with the automotive regulations.

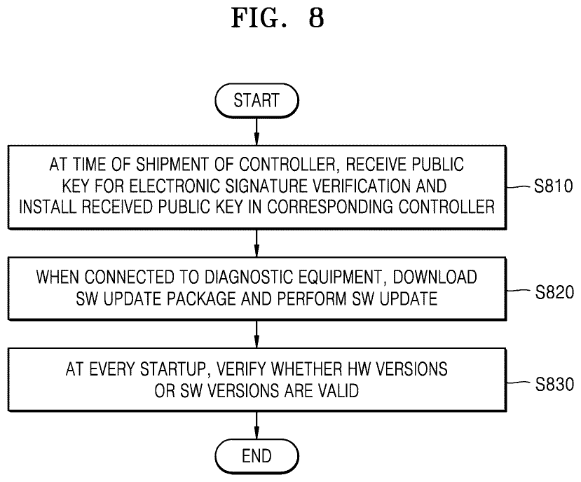

FIG. 8 is a flowchart for describing a method of managing secure SW updates for compliance with automotive regulations, according to an embodiment. In the following description, redundant descriptions provided above with reference to FIGS. 1 to 7 will be omitted.

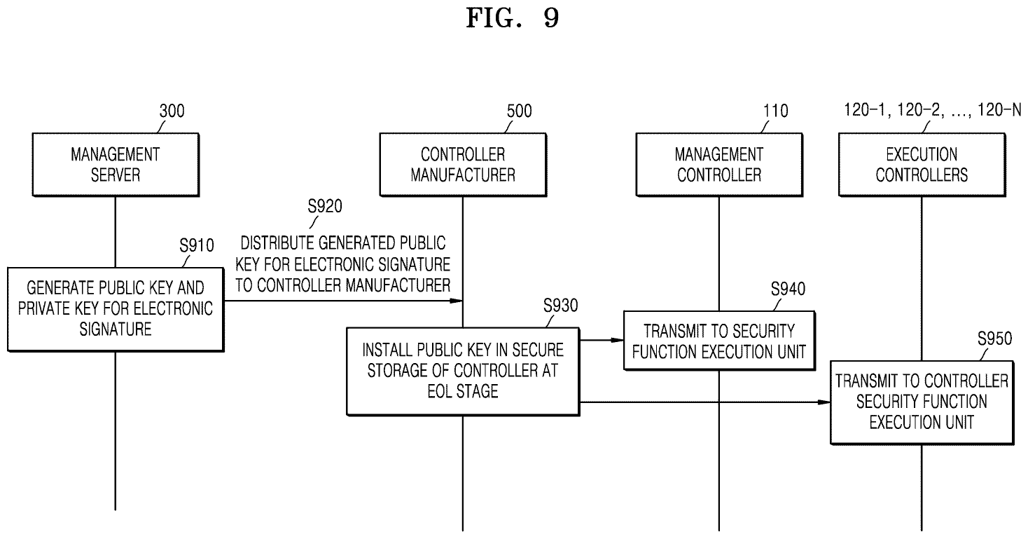

Referring to FIG. 8, in operation S810, at the time of shipment of a controller including the management controller 110 and the plurality of execution controllers 120-1, 120-2, . . . , 120-N, a controller manufacturer 500 (see FIG. 9) may receive a public key for electronic signature verification distributed from the management server 300 and install the public key in the controller.

In operation S820, when the diagnostic equipment 200 is connected to the vehicle 100, the management controller 110 may download an SW update package from the management server 300 via the diagnostic equipment 200, and perform an SW update.

In operation S830, the management controller 110 may verify whether HW versions and SW versions are valid, at every startup of the vehicle 100.

FIG. 9 is a flowchart for describing a method of installing a public key for electronic signature in a controller (S810), in the method of managing SW updates of FIG. 8, according to an embodiment. In the following description, redundant descriptions provided above with reference to FIGS. 1 to 8 will be omitted.

Referring to FIG. 9, in operations S910 and S920, the management server 300 may generate a public key and a private key for electronic signature, and distribute the generated public key for electronic signature to the controller manufacturer 500.

In operation S930, the controller manufacturer 500 may install the public key in the secure storage 115 of the management controller 110 and the controller secure storages 123-1, 123-2, . . . , 123-N of the plurality of execution controllers 120-1, 120-2, . . . , 120-N, at an EOL stage, i.e., at the time of shipment of the controller.

In operation S940, the management controller 110 may transmit, to the security function execution unit 114, the public key for electronic signature, which is obtained from the diagnostic equipment and stored in the secure storage 115, to be used for an SW update.

In operation S950, the plurality of execution controllers 120-1, 120-2, . . . , 120-N may transmit, to the controller security function execution units 122-1, 122-2, . . . , 122-N, the public key, which is obtained from the diagnostic equipment and stored in the controller secure storages 123-1, 123-2, . . . , 123-N, to be used for an SW update.

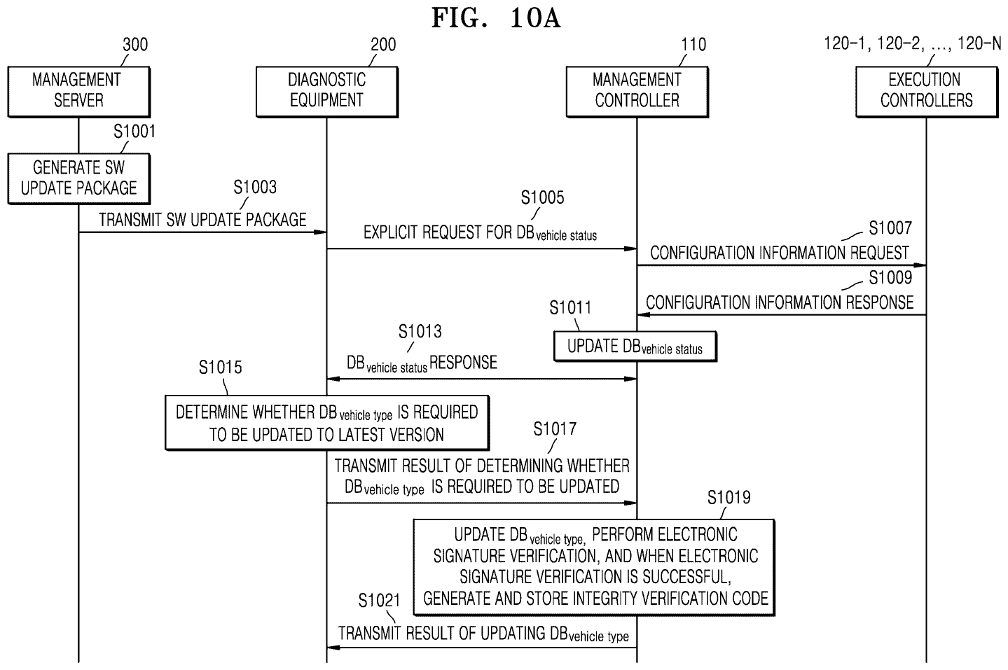

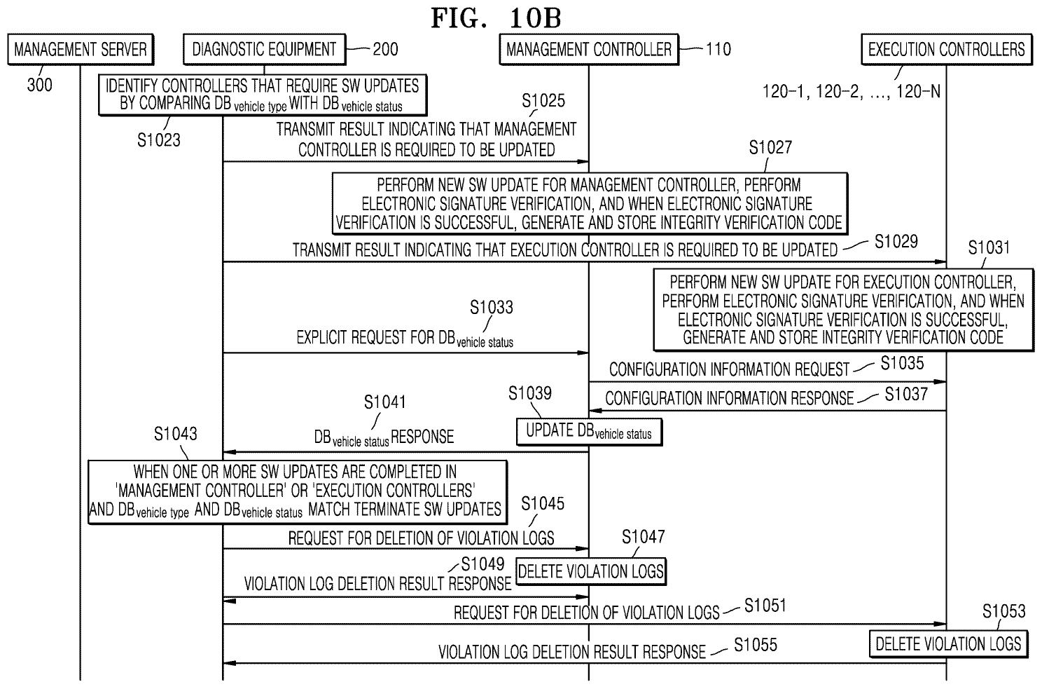

FIGS. 10A and 10B are flowcharts for describing a method of performing an SW update (S820), in the method of managing SW updates of FIG. 8, according to an embodiment. In the following description, redundant descriptions provided above with reference to FIGS. 1 to 9 will be omitted. The method of performing an SW update according to the present embodiment will be described assuming that the method is performed by the management controller 110. The method of performing an SW update according to another embodiment may be performed by a processor (not shown) included in the management controller 110. In addition, some initial operations in FIGS. 10A and 10B are preparatory operations for an SW update, and may be performed by the diagnostic equipment 200 or the management server 300.

Referring to FIGS. 10A and 10B, in operations S1001 and S1003, the management server 300 may generate an SW update package and transmit the SW update package to the diagnostic equipment 200. According to an embodiment, the diagnostic equipment 200 may make an explicit query to the management server 300 about whether there is a new SW update package, and the management server 300 that have received the query may generate an SW update package based on the status of the diagnostic equipment and transmit the SW update package to the diagnostic equipment 200. Thereafter, when the diagnostic equipment 200 is connected to the vehicle 100, an SW update may be initiated. In a case of a connectivity car, even without a connection to the diagnostic equipment 200, the management server 300 may transmit a generated SW update package to the management controller 110 or the plurality of execution controllers 120-1, 120-2, . . . , 120-N.

In operations S1005, S1007, and S1009, when the diagnostic equipment 200 explicitly requests the vehicle status database DB_{vehicle status} from the management controller 110, the management controller 110 may request configuration information from the plurality of execution controllers 120-1, 120-2, . . . , 120-N and receive the configuration information from the plurality of execution controllers 120-1, 120-2, . . . , 120-N.

In operation S1011, the management controller 110 may receive the configuration information from the plurality of execution controllers 120-1, 120-2, . . . , 120-N and update the vehicle status database DB_{vehicle status}. Here, the vehicle status database DB_{vehicle status} may also include configuration information about the management controller 110.

In operation S1013, in response to an explicit request for the vehicle status database DB_{vehicle status}, the management controller 110 may transmit the updated vehicle status database DB_{vehicle status} to the diagnostic equipment 200.

In operations S1015 and S1017, the diagnostic equipment 200 may determine whether it is necessary to update the existing vehicle type database DB_{vehicle type} to a new vehicle type database DB_{vehicle type}, and transmit, to the management controller 110, a result of determining whether an update is necessary. In the present embodiment, updating the existing vehicle type database DB_{vehicle type} to a new vehicle type database DB_{vehicle type} may include updating the existing vehicle type database DB_{vehicle type} to a vehicle type database DB_{vehicle type} based on the latest version of the master database DBₘₐₛₜₑᵣ. The diagnostic equipment 200 may compare the existing vehicle type database DB_{vehicle type} with the new vehicle type database DB_{vehicle type} and, when they are different from each other, generate a result determining that an update of the vehicle type database DB vehicle type is required.

In operations S1019 and S1021, the management controller 110 may update the vehicle type database DB_{vehicle type} and transmit, to the diagnostic equipment 200, a result of updating the vehicle type database DB_{vehicle type}. The management controller 110 may update the vehicle type database DB_{vehicle type}, perform electronic signature verification on the updated vehicle type database DB_{vehicle type}, and when verification is successful, generate and store an integrity verification code. The management controller 110 may perform electronic signature verification on the updated vehicle type database DB_{vehicle type} by using a public key for electronic signature verification stored in the secure storage 115. The management controller 110 may generate a symmetric key for integrity verification that is generated during the process of updating the vehicle type database DB_{vehicle type}, and generate and store an integrity verification code by using the symmetric key. The management controller 110 may transmit, to the diagnostic equipment 200, a result of updating the vehicle type database DB_{vehicle type}.

In operation S1023, the management controller 110 may collect, from the diagnostic equipment 200, a result of identifying controllers that require SW updates. The diagnostic equipment 200 may compare the vehicle type database DB_{vehicle type} with the vehicle status database DB_{vehicle status}, identify, when they are different from each other, the management controller 110 or one or more of the plurality of execution controllers 120-1, 120-2, . . . , 120-N that require SW updates, and transmit the identification result to the corresponding management controller 110 or execution controllers 120-1, 120-2, . . . , 120-N. In the present embodiment, when the vehicle type database DB_{vehicle type} and the vehicle status database DB_{vehicle status} are identical to each other, and there is a recommended additional update-required item in the vehicle status database DB_{vehicle status}, the diagnostic equipment 200 may generate a controller identification result for a controller that requires an SW update, from a determination result that the vehicle 100 is in compliance with the automotive regulations. When the vehicle type database DB_{vehicle type} and the vehicle status database DB_{vehicle status} are identical to each other, and there is a mandatory additional update-required item in the vehicle status database DB_{vehicle status}, the diagnostic equipment 200 may generate a controller identification result for a controller that requires an SW update, from a determination result that the vehicle 100 is not in compliance with the automotive regulations. When it is determined, by comparing the updated vehicle type database DB_{vehicle type} with the vehicle status database DB vehicle status, that the management controller 110 has different SW version information, the diagnostic equipment 200 may generate an identification result indicating that an SW update of the management controller 110 is required. When it is determined, by comparing the updated vehicle type database DB_{vehicle type} with the vehicle status database DB_{vehicle status}, that one or more of the plurality of execution controllers 120-1, 120-2, . . . , 120-N have different SW version information, the diagnostic equipment 200 may generate an identification result indicating that SW updates of the execution controllers 120 are required. The diagnostic equipment 200 may transmit the identification result to the corresponding management controller 110 or execution controllers 120-1, 120-2, . . . , 120-N.

In operations S1025 and S1027, based on collecting, from the diagnostic equipment 200, an identification result indicating that an SW update of the management controller 110 is required, the management controller 110 may update the existing SW to new SW for the management controller. For the update, the management controller 110 may download new SW for the management controller from the management server 300 via the diagnostic equipment 200, and update the existing SW for the management controller to the new SW. The management controller 110 may perform electronic signature verification of the new SW for the updated management controller using the public key for electronic signature verification, and when the electronic signature verification is successful, generate and store an integrity verification code.

In operations S1029 and S1031, the diagnostic equipment 200 may transmit, to one or more of the plurality of execution controllers 120-1, 120-2, . . . , 120-N, an identification result indicating that the one or more of execution controllers 120-1, 120-2, . . . , 120-N require SW updates. The one or more of execution controllers 120-1, 120-2, . . . , 120-N may download new SW for the execution controllers from the diagnostic equipment 200, and update the existing SW for the execution controllers to the new SW for the execution controllers. The one or more of execution controllers 120-1, 120-2, . . . , 120-N may perform electronic signature verification of the updated new SW for the execution controllers by using a public key for electronic signature verification, and when the electronic signature verification is successful, generate and store an integrity verification code.

In operations S1033 to S1037, when the diagnostic equipment 200 explicitly requests the vehicle status database DB_{vehicle status} from the management controller 110, the management controller 110 may request configuration information from the plurality of execution controllers 120-1, 120-2, . . . , 120-N and receive the configuration information from the plurality of execution controllers 120-1, 120-2, . . . , 120-N.

In operation S1039, the management controller 110 may receive the configuration information from the plurality of execution controllers 120-1, 120-2, . . . , 120-N and update the vehicle status database DB_{vehicle status}. Here, the vehicle status database DB_{vehicle status} may also include configuration information about the management controller 110.

In operation S1041, in response to an explicit request for the vehicle status database DB_{vehicle status}, the management controller 110 may transmit the updated vehicle status database DB_{vehicle status} to the diagnostic equipment 200.

In operation S1043, when it is determined, based on the updated vehicle status database DB_{vehicle status}, that one or more SW updates are completed in the management controller 110 or one or more of the plurality of execution controllers 120-1, 120-2, . . . , 120-N, and the vehicle type database DB_{vehicle type} and the vehicle status database DB_{vehicle status} are identical to each other, the diagnostic equipment 200 may terminate the SW updates.

In operations S1045 to S1049, based on determining to terminate the SW updates, the diagnostic equipment 200 may transmit, to the management controller 110, a request for deletion of violation logs. In response to receiving the request for deletion of violation logs from the diagnostic equipment 200, the management controller 110 may search for a violation log pre-stored in the secure storage 115, and delete the violation log pre-stored in the secure storage 115. The management controller 110 may transmit, to the diagnostic equipment 200, a response including a result of deleting the violation log.

In operations S1051 to S1055, based on determining to terminate the SW updates, the diagnostic equipment 200 may transmit, to the plurality of execution controllers 120-1, 120-2, . . . , 120-N, a request for deletion of violation logs. In response to receiving the request for deletion of violation logs from the diagnostic equipment 200, one or more of the plurality of execution controllers 120-1, 120-2, . . . , 120-N may search for a violation log pre-stored in the controller secure storages 123-1, and delete the violation log pre-stored in the controller secure storages 123-1. The one or more of execution controllers 120-1, 120-2, . . . , 120-N may transmit a result of deleting the pre-stored violation log to the diagnostic equipment 200.

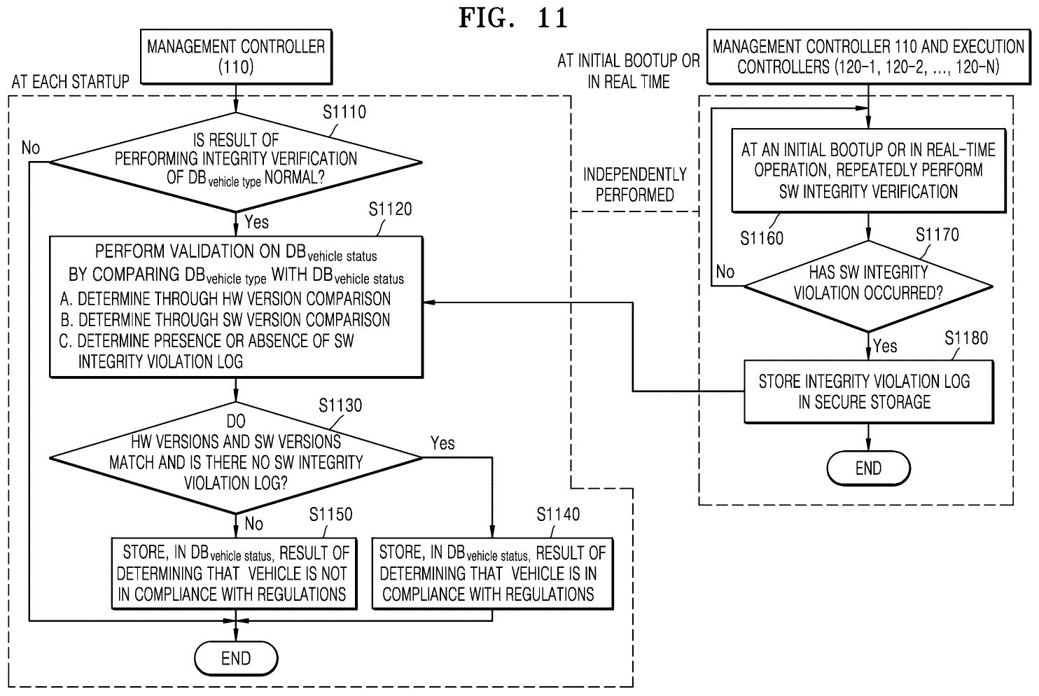

FIG. 11 is a flowchart for describing a verification method of, at each startup, determining whether HW versions or SW versions of controllers are valid (S830), in the method of managing SW updates of FIG. 8, according to an embodiment. In the following description, redundant descriptions provided above with reference to FIGS. 1 to 10B will be omitted. The verification method according to the present embodiment will be described assuming that the verification method is performed by the management controller 110. The method of performing an SW update according to another embodiment may be performed by a processor (not shown) included in the management controller 110.

Referring to FIG. 11, in operation S1110, at each startup of the vehicle 100, the management controller 110 may perform integrity verification to verify whether the vehicle type database DB_{vehicle type} has been tampered with, by using a symmetric key and an integrity verification code.

In operation S1120, when the management controller 110 successfully performs integrity verification on the vehicle type database DB_{vehicle type}, the management controller 110 may perform validation on the vehicle status database DB_{vehicle status} by comparing the vehicle type database DB_{vehicle type} with the vehicle status database DB_{vehicle status}. The management controller 110 may perform first validation to determine whether HW versions are identical to each other, by comparing the vehicle type database DB_{vehicle type} with the vehicle status database DB_{vehicle status} (A). The management controller 110 may perform second validation to determine whether SW versions are identical to each other, by comparing the vehicle type database DB_{vehicle type} with the vehicle status database DB_{vehicle status} (B). The management controller 110 may perform third validation to determine whether there is an SW integrity violation log pre-stored in the secure storage 115 (C).

In operations S1130 and S1140, the management controller 110 may determine whether the vehicle 100 is in compliance with the automotive regulations, by determining whether HW versions and SW versions are identical to each other and whether there are no SW integrity violation logs, i.e., whether first validation to third validation have been successfully performed. That is, based on determining that the HW versions are identical to each other, that the SW versions are identical to each other, that there are no pre-stored SW integrity violation logs, and thus, that the validation has been successfully performed, the management controller 110 may store, in the vehicle status database DB_{vehicle status}, information that the vehicle 100 is in compliance with the automotive regulations.

In operation S1150, when the HW versions of the vehicle status database DB_{vehicle status} are different from each other, when the SW versions are different from each other, or when there is an SW integrity violation log, the management controller 110 may determine that the vehicle 100 is not in compliance with the automotive regulations. Based on determining that the HW versions are different from each other, the SW versions are different from each other, or there are a pre-stored SW integrity violation log, and thus, that a violation has occurred in the validation, the configuration information management unit 113 may store, in the vehicle status database DB_{vehicle status}, information that the vehicle 100 is not in compliance with the automotive regulations.

In addition, in operations S1160 to S1180, at an initial bootup or in a real-time operation, the management controller 110 may perform integrity verification to verify whether SW has been tampered with, by using a symmetric key and an integrity verification code, and when a violation occurs in the integrity verification, generate a first integrity violation log and store the first integrity violation log in the secure storage 115. In addition, at an initial bootup or in a real-time operation, when violations occur in the integrity verification of the SW in the plurality of execution controllers 120-1, 120-2, . . . , 120-N, the management controller 110 may generate second integrity violation logs, and collect results stored in the controller secure storages 123-1, 123-2, . . . , 123-N. In the present embodiment, the plurality of execution controllers 120-1, 120-2, . . . , 120-N may perform integrity verification to verify whether SW has been tampered with, by using a symmetric key and an integrity verification code, and when violations occur in the integrity verification, generate second integrity violation logs and store the second integrity violation logs in the controller secure storages 123-1, 123-2, . . . , 123-N. The plurality of execution controllers 120-1, 120-2, . . . , 120-N may transmit, to the management controller 110, results of generating and storing the second integrity violation logs. The management controller 110 may perform third validation on the first integrity violation log and the second integrity violation logs.

Meanwhile, operations S1110 to S1150 may be performed at each startup of the vehicle, and operations S1160 to S1180 may be performed at an initial bootup of the controller or in real time while the vehicle is driving. According to an embodiment, operations S1110 to S1150 and operations S1160 to S1180 may be performed independently of each other.

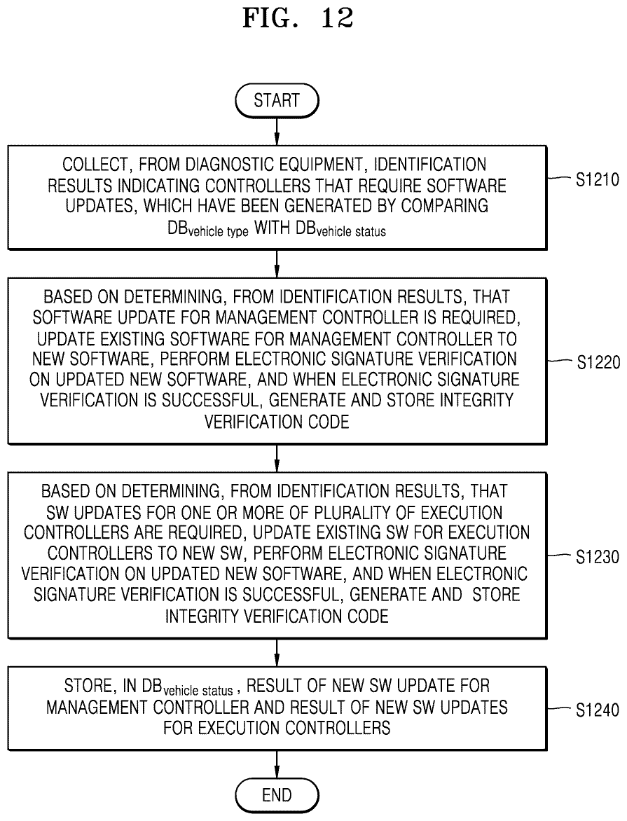

FIG. 12 is a flowchart for describing a method of performing an SW update (S820), in the method of managing SW updates of FIG. 8, according to another embodiment. In the following description, redundant descriptions provided above with reference to FIGS. 1 to 11 will be omitted. The method of performing an SW update according to the present embodiment will be described assuming that the method is performed by the management controller 110 or one or more of the plurality of execution controllers 120-1, 120-2, . . . , 120-N. The method of performing an SW update according to another embodiment may be performed by a processor (not shown) included in the management controller 110 or in one or more of the plurality of execution controllers 120-1, 120-2, . . . , 120-N.

Referring to FIG. 12, in operation S1210, the management controller 110 or one or more of the plurality of execution controllers 120-1, 120-2, . . . , 120-N may collect, from the diagnostic equipment 200, identification results indicating controllers that require SW updates, which have been generated by comparing the vehicle type database DB_{vehicle type} with the vehicle status database DB_{vehicle status}.

In operation S1220, based on determining, from the identification results, that an SW update for the management controller 110 is required, the management controller 110 may download new SW for the management controller via the diagnostic equipment 200, and update the existing SW for the management controller to the new SW. In addition, the management controller 110 may perform electronic signature verification on the updated new SW for the management controller and, when the electronic signature verification is successful, generate and store an integrity verification code.

In operation S1230, based on determining, from the identification results, that SW updates for one or more of the plurality of execution controllers 120-1, 120-2, . . . , 120-N are required, the one or more of execution controllers 120-1, 120-2, . . . , 120-N may download new SW for the execution controllers from the diagnostic equipment 200, and update the existing SW for the execution controllers to the new SW for the execution controllers. The one or more of execution controllers 120-1, 120-2, . . . , 120-N may perform electronic signature verification of the updated new SW for the execution controllers by using a public key for electronic signature verification, and when the electronic signature verification is successful, generate and store an integrity verification code.

In operation S1240, the management controller 110 may store, in the vehicle status database DB_{vehicle status}, a result of the new SW update for the management controller and a result of the new SW updates for the execution controllers. Here, the storing of the result of the new SW update for the management controller and the result of the new SW updates for the execution controllers in the vehicle status database DB_{vehicle status} may be performed when the diagnostic equipment 200 explicitly requests the vehicle status database DB_{vehicle status} from the management controller 110. In more detail, when the diagnostic equipment 200 explicitly requests the vehicle status database DB_{vehicle status} from the management controller 110, the management controller 110 may request configuration information from the plurality of execution controllers 120-1, 120-2, . . . , 120-N, receive the configuration information from the plurality of execution controllers 120-1, 120-2, . . . , 120-N, store the configuration information in the vehicle status database DB_{vehicle status}, and transmit, to the diagnostic equipment 200, the updated vehicle status database DB_{vehicle status}.

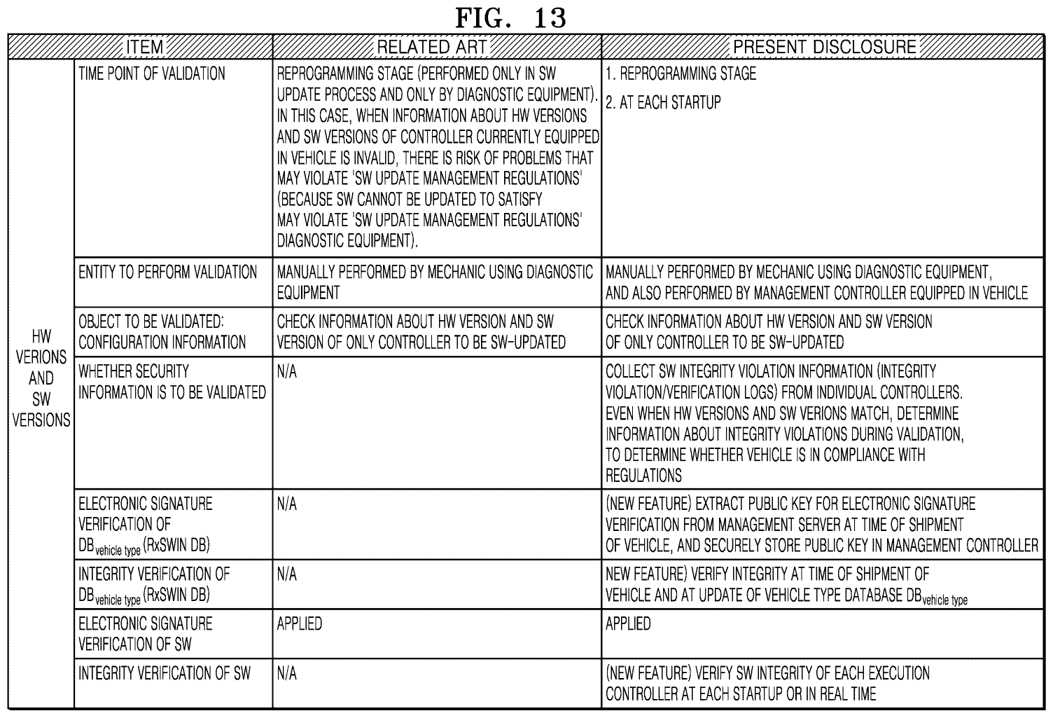

FIG. 13 is a table showing a comparison between update management according to the present embodiment and update management according to the related art. In the following description, redundant descriptions provided above with reference to FIGS. 1 to 12 will be omitted.

In general, SW updates of controllers corresponding to the vehicle type database DB_{vehicle type} are performed, but SW updates may not be performed in the following cases. The present disclosure may be required to prevent installation of invalid SW and HW in the following cases. First, there may be cases in which a hacking incident occurs, resulting in SW being downgraded or incorrect SW being installed. Second, there may be cases in which SW is arbitrarily manipulated due to tuning by the vehicle owner. Third, there may be cases in which incorrect SW or HW is installed due to a human error by a mechanic.

With reference to FIG. 13, the differences between the related art and the present disclosure will be described item by item.
1. Time point of validation of HW versions and SW versions: In the related art, validation of HW and SW versions are mainly performed only in a reprogramming stage of an SW update process. In this case, a mechanic using diagnostic equipment needs to perform it manually, and there is a risk that the SW will not be updated to satisfy the regulations until the vehicle is connected to the diagnostic equipment. In contrast, according to the present disclosure, by automatically performing a validation check at each startup of the vehicle, it is possible to continuously check and guarantee the regulatory compliance status of the vehicle.
2. Entity to perform validation: In the related art, validation is performed manually by a mechanic using diagnostic equipment, whereas, in the present disclosure, a management controller equipped in the vehicle may automatically perform validation. This may reduce human error and enable continuous validation while the vehicle is driving or stopped.
3. Object to be validated: configuration information: The related art is limited to verifying only HW and SW version information about a controller that is to be subjected to an SW update. In contrast, the present disclosure may provide more comprehensive validation by verifying HW and SW version information about all controllers equipped in the vehicle.
4. Whether security information is to be validated: According to the present disclosure, it is possible to collect SW integrity violation information about individual controllers and consider this information during a validation process so as to determine whether the vehicle is in compliance with regulations. This may be a new approach that is not considered in the related art.
5. Electronic signature verification of vehicle type database DB_{vehicle type} (RxSWIN DB): In the related art, electronic signature verification of the vehicle type database DB_{vehicle type} is not performed. In the present disclosure, a public key for electronic signature verification, which is extracted from a management server at the time of shipment of the vehicle, is securely stored in each controller, and the public key may be used for electronic signature verification of the vehicle type database DB_{vehicle type}.
6. Integrity verification of vehicle type database DB_{vehicle type} (RxSWIN DB): In the related art, integrity verification of the vehicle type database DB_{vehicle type} is not performed. In the present disclosure, when electronic signature verification is successful during an update of the vehicle type database DB_{vehicle type}, an integrity verification code may be generated and stored, and integrity verification of the vehicle type database DB_{vehicle type} may be performed at each startup by using the integrity verification code.
7. Electronic signature verification of SW: This applies to both the related art and the present disclosure, but in the present disclosure, electronic signature verification may be performed continuously throughout the entire life cycle of the vehicle.
8. Integrity verification of SW: In the related art, integrity verification of SW is not performed. In the present disclosure, it is possible to newly apply SW integrity verification of each execution controller at each startup or in real time. This allows for continuous validation and quick detection of violations even when the vehicle is not in a repair shop.

The embodiments of the present disclosure described above may be implemented as a computer program that may be executed through various components on a computer, and such a computer program may be recorded in a computer-readable medium. In this case, the medium may include a magnetic medium, such as a hard disk, a floppy disk, or a magnetic tape, an optical recording medium, such as a compact disc read-only memory (CD-ROM) or a digital video disc (DVD), a magneto-optical medium, such as a floptical disk, and a hardware device specially configured to store and execute program instructions, such as read-only memory (ROM), random-access memory (RAM), or flash memory.

Meanwhile, the computer program may be specially designed and configured for the present disclosure or may be well-known to and usable by those skilled in the art of computer software. Examples of the computer program may include not only machine code, such as code made by a compiler, but also high-level language code that is executable by a computer by using an interpreter or the like.

The term ‘the’ and other demonstratives similar thereto in the specification of the present disclosure (especially in the following claims) should be understood to include a singular form and plural forms. Furthermore, recitation of ranges of values herein are merely intended to serve as a shorthand method of referring individually to each separate value falling within the range, unless otherwise indicated herein, and each separate value is incorporated into the specification as if it were individually recited herein.

The operations of the methods according to the present disclosure may be performed in any suitable order unless otherwise indicated herein or otherwise clearly contradicted by context. The present disclosure is not limited to the described order of the operations. The use of any and all examples, or exemplary language (e.g., ‘and the like’) provided herein, is intended merely to better illuminate the present disclosure and does not pose a limitation on the scope of the present disclosure unless otherwise claimed. Also, numerous modifications and adaptations will be readily apparent to those skilled in the art without departing from the spirit and scope of the present disclosure.

Accordingly, the spirit of the present disclosure should not be limited to the above-described embodiments, and all modifications and variations which may be derived from the meanings, scopes and equivalents of the claims should be construed as failing within the scope of the present disclosure.

According to the present disclosure, it is possible to provide a clear standard for evaluating whether an individual vehicle being driven on a road after being released from a production line is in compliance with automotive regulations, regardless of an interaction between the automotive regulations and each controller, the configuration of HW or SW according to various controller options, or a history of controller replacement by a user.

According to the present disclosure, by securely performing SW updates while complying with new regulations throughout the entire life cycle of a vehicle, it is possible to continuously improve the functionality and safety of the vehicle, keeping pace with market changes and technological evolution.

In addition, by verifying the validity of the SW version of each execution controller and performing appropriate updates as needed, even when the vehicle is not at a repair shop, but is driving or stopped, it is possible to improve the safety and autonomy of the vehicle, while simultaneously and quickly eliminating risk factors through real-time responses and applying up-to-date functions.

Furthermore, through SW updates, it is possible to guarantee continuous compliance with automotive regulations and strengthen the vehicle's safety and adherence to environmental regulations.

Effects of the present disclosure are not limited to the foregoing, and other unmentioned effects would be clearly understood by those skilled in the art from the following description.

What is claimed is:

1. A method, performed by a processor of diagnostic equipment, of evaluating compliance with automotive regulations, the method comprising:
based on confirming a connection to a vehicle, collecting, from a management controller, a primary determination result on whether the vehicle is in compliance with automotive regulations by comparing a vehicle type database that stores detailed information about the vehicle, with a vehicle status database that stores current configuration information about the vehicle collected from a plurality of execution controllers;
comparing a version of the vehicle type database collected from the management controller, with a version of a master database that stores comprehensive information about all vehicle types, to determine whether the versions are identical to each other; and
generating a secondary determination result on whether the vehicle is in compliance with the automotive regulations, based on the primary determination result and a determination result on whether the version of the vehicle type database and the version of the master database are identical to each other.

2. The method of claim 1, wherein the collecting of the primary determination result comprises collecting, from the management controller, a 1-1st determination result that the vehicle is in compliance with the automotive regulations, wherein the 1-1st determination result is based on the vehicle type database and the vehicle status database being identical to each other.

3. The method of claim 2, wherein the collecting of the 1-1st determination result comprises collecting, from the management controller, a 1-1-1st determination result that the vehicle is in compliance with the automotive regulations, wherein the 1-1-1st determination result is based on the vehicle type database and the vehicle status database being identical to each other, and absence of an additional update item, collecting, from the management controller, a 1-1-2nd determination result that the vehicle is in compliance with the automotive regulations, wherein the 1-1-2nd determination result is based on the vehicle type database and the vehicle status database being identical to each other, and presence of a recommended additional update-required item, or collecting, from the management controller, a 1-1-3rd determination result that the vehicle is not in compliance with the automotive regulations, wherein the 1-1-3rd determination result is based on the vehicle type database and the vehicle status database being identical to each other, and presence of a mandatory additional update-required item.

4. The method of claim 1, wherein the collecting of the primary determination result comprises collecting, from the management controller, a 1-2nd determination result that the vehicle is not in compliance with the automotive regulations, wherein the 1-2nd determination result is based on the vehicle type database and the vehicle status database being different from each other.

5. The method of claim 1, wherein the generating of the secondary determination result comprises, based on the version of the vehicle type database and the version of the master database being identical to each other, determining the primary determination result as a 2-1st determination result.

6. The method of claim 1, wherein the generating of the secondary determination result comprises, based on the version of the vehicle type database and the version of the master database being different from each other, and the master database being a recommended update item, determining the primary determination result as a 2-2nd determination result.

7. The method of claim 6, further comprising, after the determining as the 2-2nd determination result, outputting the 2-2nd determination result and information that an optional update item exists.

8. The method of claim 1, wherein the generating of the secondary determination result comprises, based on the version of the vehicle type database and the version of the master database being different from each other, and the master database being a mandatory update item, generating a 2-3rd determination result that the vehicle is not in compliance with the automotive regulations.

9. The method of claim 8, further comprising, after the generating of the 2-3rd determination result, transmitting, to the management controller, update information and a command to update the vehicle type database.

10. A device for evaluating compliance with automotive regulations, the device comprising:
a processor; and
a memory operatively connected to the processor and storing at least one piece of code to be executed by the processor,
wherein the memory stores code that, when executed by the processor, causes the processor to, based on confirming a connection to a vehicle, collect, from a management controller, a primary determination result on whether the vehicle is in compliance with automotive regulations by comparing a vehicle type database that stores detailed information about the vehicle, with a vehicle status database that stores current configuration information about the vehicle collected from a plurality of execution controllers, compare a version of the vehicle type database collected from the management controller, with a version of a master database that stores comprehensive information about all vehicle types, to determine whether the versions are identical to each other, and generate a secondary determination result on whether the vehicle is in compliance with the automotive regulations, based on the primary determination result and a determination result on whether the version of the vehicle type database and the version of the master database are identical to each other.

11. A method, performed by a management controller installed in a vehicle, of evaluating compliance with automotive regulations, the method comprising:
collecting, from a plurality of execution controllers, a vehicle state database that stores current configuration information about the vehicle;
determining whether the vehicle is in compliance with automotive regulations, by comparing a vehicle type database that stores detailed information about the vehicle, with the vehicle status database; and
recording, in the vehicle status database, a result of determining whether the vehicle is in compliance with the automotive regulations.

12. The method of claim 11, further comprising, before the collecting of the vehicle status database, determining whether a regulatory evaluation function stored in the vehicle type information storage is activated.

13. The method of claim 11, wherein the determining of whether the vehicle is in compliance with the automotive regulations comprises, based on the vehicle type database and the vehicle status database being identical to each other, generating a 1-1st determination result that the vehicle is in compliance with the automotive regulations, or based on the vehicle type database and the vehicle status database being different from each other, generating a 1-2nd determination result that the vehicle is not in compliance with the automotive regulations.

14. The method of claim 13, wherein the generating of the 1-1st determination result comprises, based on the vehicle type database and the vehicle status database being identical to each other, and absence of an additional update item, generating a 1-1-1st determination result that the vehicle is in compliance with the automotive regulations, based on the vehicle type database and the vehicle status database being identical to each other, and presence of a recommended additional update-required item, generating a 1-1-2nd determination result that the vehicle is in compliance with the automotive regulations, or based on the vehicle type database and the vehicle status database being identical to each other, and presence of a mandatory additional update-required item, generating a 1-1-3rd determination result that the vehicle is not in compliance with the automotive regulations.

15. The method of claim 14, wherein the generating of the 1-1-2nd determination result comprises performing an update for the recommended additional update-required item, according to a selection by a user.
